(19) United States
(12) Patent Application Publication
(10) Pub. No.: US 2010/0332722 A1
(43) Pub. Date: Dec. 30, 2010

(54) VIRTUAL MACHINE SYSTEM AND CONTROL METHOD THEREOF

(75) Inventors: Eiichiro OIWA, Tone (JP); Naoya HATTORI, Kokubunji (JP); Toshiomi MORIKI, Kokubunji (JP); Yuji TSUSHIMA, Hachioji (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/819,416

(22) Filed: Jun. 21, 2010

(30) Foreign Application Priority Data
Jun. 26, 2009 (JP) 2009-151738

(51) Int. Cl. G06F 12/00; G06F 9/455

(52) U.S. Cl. 711/6; 718/1; 711/E12.001

(57) ABSTRACT

In a two-level virtual machine system having child VMMs operating on a parent VMM, the field update frequency of VMCS and VMCB which control a VMM assist function of a CPU is not uniform. A G field requiring reflection of emulation results is higher in update frequency than a C field. The semiconductor quantity and power dissipation caused by the assist function expansion tend to increase in the C field used for a condition decision as compared with the G field simply retaining a value because influence upon the CPU operation is greater in the C field. Therefore, events relating to the G field which is high in update frequency and less in increase of semiconductor quantity and power dissipation caused by the assist function expansion are coped with by the CPU with its assist function expanded. Events relating to the C field are coped with by the parent VMM.

### INCORPORATION BY REFERENCE

The present application claims priority from Japanese application JP2009-151738 filed on Jun. 26, 2009, the content of which is hereby incorporated by reference into this application.

### BACKGROUND OF THE INVENTION

The present invention relates to a two-level virtual machine system in which a virtual machine (VM) is caused to operate on another virtual machine, and relates to a technique for emulating a virtualization support function of a CPU on a virtual machine with a low delay. In particular, the present invention relates to a method for improving the emulation performance of a virtualization support CPU in the two-level virtual machines.

As the number of servers increases, complexity concerning the operation increases, and the operation cost poses a problem. As a technique for reducing the operation cost, therefore, server integration for putting together a plurality of servers into one is attracting attention. As a technique for implementing the server integration, the virtual machine technique in which one computer is logically divided at an arbitrary ratio is known. In the virtual machine technique, firmware (or middleware) such as, for example, a hypervisor, divides a physical machine into a plurality of LPARs (Logical PARtitions), assigns machine resources (CPUs, memories, and I/O devices) to respective LPARs, and causes OSs to operate on respective LPARs. Or the firmware (or middleware) executes one host OS (an OS which directly uses a physical machine) on one server, and a hypervisor operating on the host OS conducts similar division processing and causes a plurality of guest OSs (OSs operating on the host OS) to operate. The virtual machine technique makes it possible to cause OSs which have conventionally operated on a plurality of servers and software which operates on the OSs to operate on one server, and implements server integration.

The virtual machine technique is a technique which has been used in large-sized machines such as general purpose machines (main frames). As the performance of microprocessors has been improved in recent years, however, the virtual machine technique has spread in low end servers as well. A machine, such as a server, using the virtual machine technique includes a plurality of virtual machines each of which causes a guest (which is a general term of guest OS and software operating on the guest OS) to operate and a virtual machine monitor (hereafter abbreviated to VMM) which controls the virtual machines.

Among low end servers, especially the x86 CPU provides and expands the function of supporting the VMM. The x86 server having the x86 CPU mounted thereon improves the performance of the virtual machines. It is conjectured that the performance of the x86 server will be improved continuously from now on as well, and the number of guests which can operate on one server tends to increase.

Advance of this tendency brings about a fear that a large number of guests will stop all together. An occupation scheme in which a single guest is caused to occupy machine resources (CPUs, memories and I/O devices) to minimize the influence range at the time of a failure and enhance the reliability is effective to this fear. On the other hand, in the VMM, there is also a sharing scheme in which the machine resources are caused to be shared by a plurality of guests. In the sharing scheme, the machine resources can be assigned flexibly by, for example, utilizing idle time of the machine resources, resulting in a merit of improved convenience.

Since both the reliability and convenience are important, a method of balancing the reliability with convenience by causing a VMM of the occupation scheme (parent VMM) and a VMM of the sharing scheme (child VMM) to operate in superposition between the server and the OS is considered to gradually fix from now on. This form is called two-level virtual machine system. However, the x86 CPU at the present time copes with only one-level virtual machine system. Hereafter, an outline of functions mounted on the current x86 CPU and problems posed when constructing a two-level virtual machine system will be described.

The current x86 CPU has an assist function of monitoring operation of each guest, and interrupting the operation of the guest and calling the VMM in response to occurrence of a specific event. The assist function is called VT (Virtualization Technology) in the CPU from Intel Corporation and called SVM (Secure Virtual Machine) in the CPU from AMD Corporation. The interruption is called VMEXIT.

In the assist function, the state of the CPU in the guest operation is saved when the guest operation is interrupted and restored when the guest operation is resumed. When a guest conducts operation which affects another guest (for example, power off), the VMM utilizes the assist function and conducts emulation (alternative processing) such as stopping the execution of the guest instead of turning off the power supply of the server. At the time of emulation, the VMM changes the guest state in the memory.

The VMM calling condition differs depending upon the VMM policy. For example, in the sharing scheme, operation of an I/O device conducted by a guest influences other guests and consequently it is necessary to restrict access. In the occupation scheme, however, a guest may operate an I/O device. Therefore, the x86 CPU can set the VMM calling condition finely in correspondence to difference in VMM policy. Furthermore, the x86 CPU can specify areas to be used for saving and restoring the guest state. In the CPU from Intel, areas used for the VMM calling condition and the guest state saving and restoration are included in a data structure called VMCS (Virtual Machine Control Structure), and referred to from a VMCS pointer in the CPU. In the CPU from AMD, the areas used for the VMM calling condition and the guest state saving and restoration are included in a data structure called VMCB (Virtual Machine Control Block), and referred to from a VMCB pointer in the CPU. Hereafter, the area storing the VMM calling condition is referred to a condition field and abbreviated to C field, and the area used to save and restore the guest state is referred to as guest state field and abbreviated to G field.

The current x86 CPU corresponds to only the one-level virtual machine system. For constructing a two-level virtual machine system, therefore, the parent VMM conducts emulation of the assist function and causes the child VMM to operate (US2009/0007112A, Moriki et al.). The parent VMM generates and manages VMCS of two kinds (which corresponds to VMCB in the case of the CPU from AMID, which is true of the ensuing description) corresponding to the subject of operation (child VMM/OS). Furthermore, the parent VMM refers to and updates VMCS generated by the child VMM as well, as occasion demands. Hereafter, they are referred to as parent VMCS for child VMM, parent VMCS for OS, and child VMCS, respectively.

During operation of the child VMM, the C field of the child VMCS and the G field of the child VMCS are updated. When the child VMM resumes the OS, therefore, the parent VMM regenerates the C field of the parent VMCS for OS so as to include the C field of the child VMCS and copies the G field of the child VMCS into the G field of the parent VMCS for OS. After the processing described heretofore is completed, the parent VMM causes the OS to operate by using the parent VMCS for OS. In the present method, however, there is a problem that the performance falls when resuming the OS operation.

A technique for generating and managing data structures of two kinds corresponding to an operation subject (OS/application) as regards a page table of a one-level virtual machine system is disclosed in US2006/0294519A, Hattori et al. According to the present technique, the VMM updates data structures of two kinds corresponding to the OS/application when the OS updates the page table. When changing over the operation subject, only activation of the data structure is conducted to reduce the performance degradation caused by the changeover. This technique is a technique oriented towards the one-level virtual machine system. However, this technique can be applied to the two-level virtual machine system by reading “child VMM/OS” for “OS/application” and reading “VMCS” for “page table.”

A technique for expanding the assist function of the CPU to cope with a two-level virtual machine system on the main frame is disclosed in U.S. Pat. No. 5,109,489, Umeno et al. According to the technique, the parent VMM operates by utilizing an assist function at the first level and the child VMM operates by utilizing an assist function at the second level. Since the use of the technique makes software processing unnecessary, performance degradation caused when resuming the OS operation can be reduced.

A technique of expanding the assist function of the CPU to cope with a multilevel virtual machine system on the x86 CPU is disclosed in US2007/0028238A, Bennett et al. According to the technique, the parent VMM operates by utilizing an assist function at the first level and the child VMM operates by utilizing an assist function at the second level. Since the use of the technique also makes software processing unnecessary as well as U.S. Pat. No. 5,381,535, Gum et al., performance degradation caused when resuming the OS operation can be reduced.

### SUMMARY OF THE INVENTION

In the technique described in US2006/0294519A, the parent VMM operates when updating the child VMCS, resulting in performance degradation. Furthermore, also when the OS operation is resumed, processing of the parent VMM is needed, resulting in performance degradation. In the techniques described in U.S. Pat. No. 5,109,489 and US2007/0028238A, large-scale function expansion which is the same degree as that in the case where an assist function is newly introduced is required of the CPU. The large-scale function expansion increases the quantity of semiconductors mounted on the CPU and power dissipation.

As appreciated from the foregoing description, there is a fear that at least one of the problems, i.e., the increase of the semiconductor quantity and power dissipation, the performance degradation at the time of child VMCS update, and the performance degradation at the time of OS operation resumption will occur in the conventional techniques.

In virtual machines and a control method of the virtual machines according to the present invention, control described below is exercised in a virtual machine system which provides a plurality of virtual machines executed on a physical machine including a physical CPU and a storage part (for example, a memory) in order to solve the problem.

A virtual machine system includes a first virtual machine monitor (parent VMM) which operates on a physical machine to provide virtual machines, and a second virtual machine monitor (child VMM) which operates on each of the virtual machines to execute a user program (for example, an OS). The second virtual machine monitor includes a first data structure prescribing an event which becomes a condition of calling the second virtual machine monitor during operation of the user program, and a third data structure which becomes a saving/restoration destination of a state of the physical CPU when interrupting/resuming the user program. The first virtual machine monitor includes a second data structure prescribing an event which becomes a condition of calling the first virtual machine monitor, and a field partition table for managing the first data structure and the second data structure as data structures to be subject to update processing conducted by the first virtual machine monitor which is called by the physical CPU and managing the third data structure as a data structure to be subject to update processing conducted by the physical CPU. When the second virtual machine monitor updates the data structures, if the first data structure is to be updated, a physical CPU with the second virtual machine monitor designated as an operation subject thereof calls the first virtual machine monitor on the basis of the partition table, and the called first virtual machine monitor updates the first data structure, and adds all of events prescribed in the updated first data structure to the second data structure. When the second virtual machine monitor updates the data structures, if the third data structure is to be updated, the physical CPU with the second virtual machine monitor designated as the operation subject thereof updates the third data on the basis of the field partition table.

According to the present invention, it is possible to provide a method for raising the speed of both the child VMCS update and the OS operation resumption while holding down the increase of the semiconductor quantity and power dissipation to the minimum.

Since the expanded assist function is restricted to G field relating events, the increase of the semiconductor quantity and power dissipation can be held down to the minimum. Furthermore, in the steady state in which the C field is not updated, the speed of both the child VMCS update and the OS operation resumption can be raised.

Other objects, features and advantages of the invention will become apparent from the following description of the embodiments of the invention taken in conjunction with the accompanying drawings.

### BRIEF DESCRIPTION OF THE DRAWINGS

FIG. 1 is a flow chart of child VMCS writing in first and third embodiments;

FIG. 2 is a block diagram of a physical machine which causes a virtual machine system to operate in first to fourth embodiments;

FIG. 3 is a stack diagram showing principal parts of software and hardware of a virtual machine system in the first embodiment;

FIG. 4 is a block diagram showing contents of a main storage in the first embodiment;

FIG. 5 is a configuration diagram of a field partition table in the first to fourth embodiments;

FIG. 6A is a configuration diagram of an operation subject flag in the first and second embodiments;

FIG. 6B is a configuration diagram of an operation subject flag in the third and fourth embodiments;

FIG. 7 is a flow chart showing an operation outline of the virtual machine system in the first to fourth embodiments;

FIG. 8A is a flow chart of virtual machine initialization in the first embodiment;

FIG. 8B is a flow chart of parent VMM calling in the first embodiment;

FIG. 8C is a flow chart of virtual machine resumption in the first embodiment;

FIG. 9 is a flow chart of OS-oriented processing in the first embodiment;

FIG. 10 is a flow chart of child VMM-oriented processing in the first and second embodiments;

FIG. 11A is a flow chart of VMENTRY in the first embodiment;

FIG. 11B is a flow chart of VMPTRLD in the first embodiment;

FIG. 12 is a stack diagram showing principal parts of software and hardware of a virtual machine system in the second embodiment;

FIG. 13 is a block diagram showing contents of a main storage in the second embodiment;

FIG. 14A is a flow chart of virtual machine initialization in the second embodiment;

FIG. 14B is a flow chart of parent VMM calling in the second embodiment;

FIG. 14C is a flow chart of virtual machine resumption in the second embodiment;

FIG. 15 is a flow chart of OS-oriented processing in the second embodiment;

FIG. 16 is a flow chart of VMENTRY in the second embodiment;

FIG. 17A is a flow chart of child VMCS reading in the second embodiment;

FIG. 17B is a flow chart of child VMCS writing in the second embodiment;

FIG. 17C is a flow chart of child VMCB reading in the fourth embodiment;

FIG. 17D is a flow chart of child VMCB writing in the fourth embodiment;

FIG. 18A is a flow chart of VMCLEAR in the second embodiment;

FIG. 18B is a flow chart of VMPTRLD in the second embodiment;

FIG. 18C is a flow chart of VMPTRST in the second embodiment;

FIG. 19 is a stack diagram showing principal parts of software and hardware of a virtual machine system in the third embodiment;

FIG. 20 is a block diagram showing contents of a main storage in the third and fourth embodiments;

FIG. 21A is a flow chart of virtual machine initialization in the third embodiment;

FIG. 21B is a flow chart of parent VMM calling in the third embodiment;

FIG. 21C is a flow chart of virtual machine resumption in the third embodiment;

FIG. 22 is a flow chart of OS-oriented processing in the third embodiment;

FIG. 23 is a flow chart of child VMM-oriented processing in the third and fourth embodiments;

FIG. 24 is a flow chart of VMRUN in the third embodiment;

FIG. 25 is a stack diagram showing principal parts of software and hardware of a virtual machine system in the fourth embodiment;

FIG. 26A is a flow chart of virtual machine initialization in the fourth embodiment;

FIG. 26B is a flow chart of parent VMM calling in the fourth embodiment;

FIG. 26C is a flow chart of virtual machine resumption in the fourth embodiment;

FIG. 27 is a flow chart of OS-oriented processing in the fourth embodiment;

FIG. 28 is a flow chart of VMRUN in the fourth embodiment;

FIG. 29A shows a format of VMCS in the first and second embodiments;

FIG. 29B shows a format of VMCB in the third and fourth embodiments.

### DESCRIPTION OF THE EMBODIMENTS

First, an outline of a point found by the present inventors as regards the present invention will be described. The frequency of the field update of VMCS is not uniform, but a G field which needs to reflect a result of emulation is high in update frequency. Furthermore, a C field used for a condition decision exerts greater influence upon the CPU operation as compared with the G field used as a saving destination. Therefore, it is considered that expansion of the assist function for the C field tends to increase the semiconductor quantity and power dissipation.

Therefore, an event concerning the G field which is high in update frequency and less in increase of semiconductor quantity and power dissipation caused by assist function expansion is coped with by only the CPU. On the other hand, an event concerning the C field which is low in update frequency and more in increase of semiconductor quantity and power dissipation caused by the assist function expansion is coped with by the parent VMM.

Each of VMCS fields has a size of several bytes, and a large number of VMCS fields are included in a 4-kB memory area. In the conventional art, however, a processing policy of only one kind, such as coping with by only the CPU/coping with by the parent VMM is determined every 4 KB. In the present invention, therefore, a field partition table for making a distinction between the C field and the G field by using a fine unit of approximately several bytes to determine a processing policy, and a field decision part which determines a processing policy by referring to the field partition table are introduced to select processing which is optimum to each field. Furthermore, a common memory area is used as the G field of the child VMCS and the G field of the parent VMCS for OS.

If an event described in the C field of the parent VMCS for OS has occurred during operation of the OS, the CPU state is saved into the C field of the common memory area and the parent VMM is called. The parent VMM makes a decision whether an event described in the C field of the child VMCS has occurred. If an event described in the C field of the child VMCS has occurred, then the parent VMM causes operation of the child VMM to resume by using the parent VMCS for child VMM.

When the child VMM updates the child VMCS, the CPU judges an object field by referring to the field partition table. If the G field is to be updated, the CPU updates the G field of the common memory area. On the other hand, if the C field is to be updated, the CPU calls the parent VMM. The parent VMM updates the C field of the child VMCS. In addition, the parent VMM changes the C field of the parent VMCS for OS so as to include all events of the C field of the child VMCS, and causes the operation of the child VMM to resume.

When the child VMM resumes the operation of the OS, the CPU restores the CPU state from the G field of the common memory area and causes the operation of the OS to resume.

Hereafter, embodiments of the present invention will be described in detail with reference to the drawings.

### First Embodiment

In the present embodiment, the child VMM is caused to utilize the VT function. Furthermore, the G field of the child VMCS is used as the G field of the parent VMCS for OS as well, and used as the common memory area. In the present embodiment, update of the child VMCS conducted by the child VMM is reflected to the parent VMCS for OS instantly or when the OS operation is resumed next time.

### <1. Hardware Configuration>

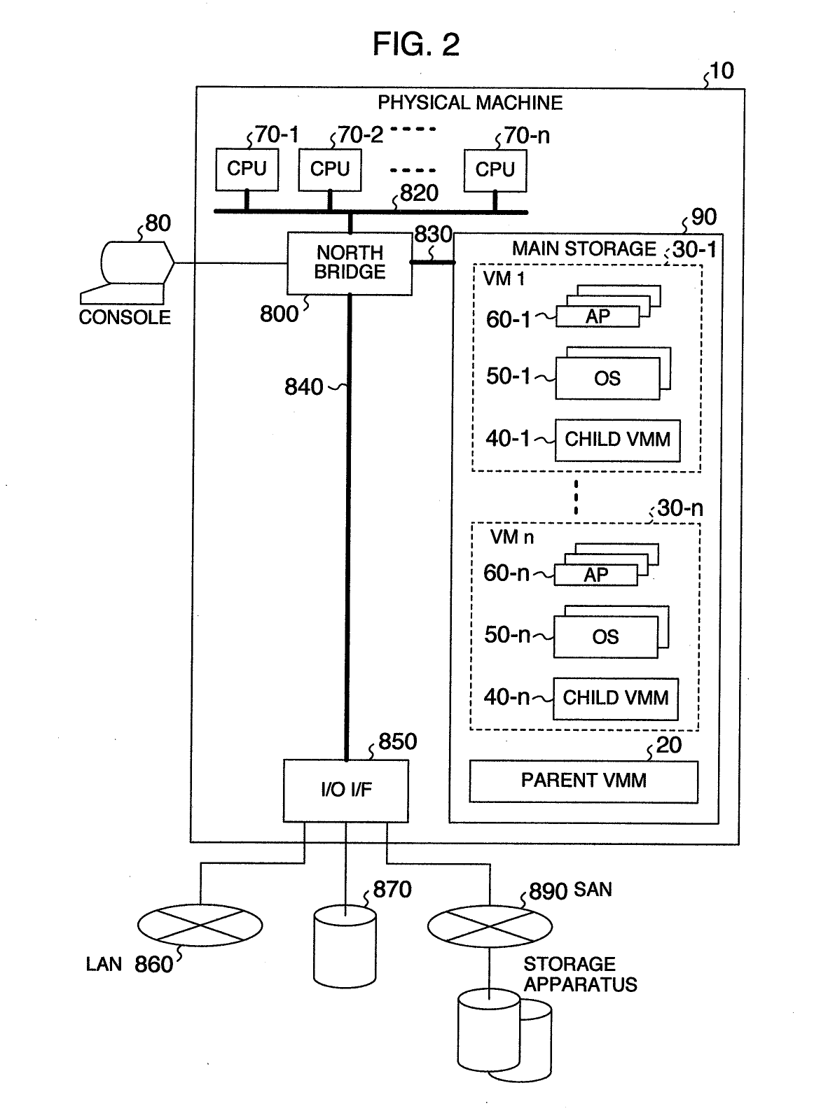

FIG. 2 shows a configuration of a physical machine which causes a two-level virtual machine system to operate in the first embodiment of the present invention.

The physical machine includes at least one CPU 70 corresponding to the VT function. These CPUs 70 are connected to a north bridge 800 (or a memory controller) via an inter-CPU interface 820 represented by a FSB (Front Side Bus).

A main storage 90 is connected to the north bridge 800 via a memory bus 830. Furthermore, an I/O device 850 is connected to the north bridge 800 via a bus 840. The I/O device 850 includes a network adaptor connected to a LAN 860, an SCSI adapter connected to a disk device 870 or the like, and a fiber channel adaptor connected to a SAN (Storage Area Network) 890. The CPU 70 accesses the memory via the north bridge 800, accesses the I/O device 850 from the north bridge 800, and conducts predetermined processing. By the way, the north bridge 800 controls the main storage 90. The north bridge 800 includes a graphic controller. The north bridge 800 is connected to a console 80 as well to display an image. A parent VMM (Virtual Machine Monitor) 20 of the two-level virtual machine system is loaded into the main storage 90. A virtual machine 30 implemented by the parent VMM 20 executes a child VMM 40. The child VMM executes arbitrary OS 50 and AP (Application) 60 on the virtual machine 30.

### <2. Software Configuration>

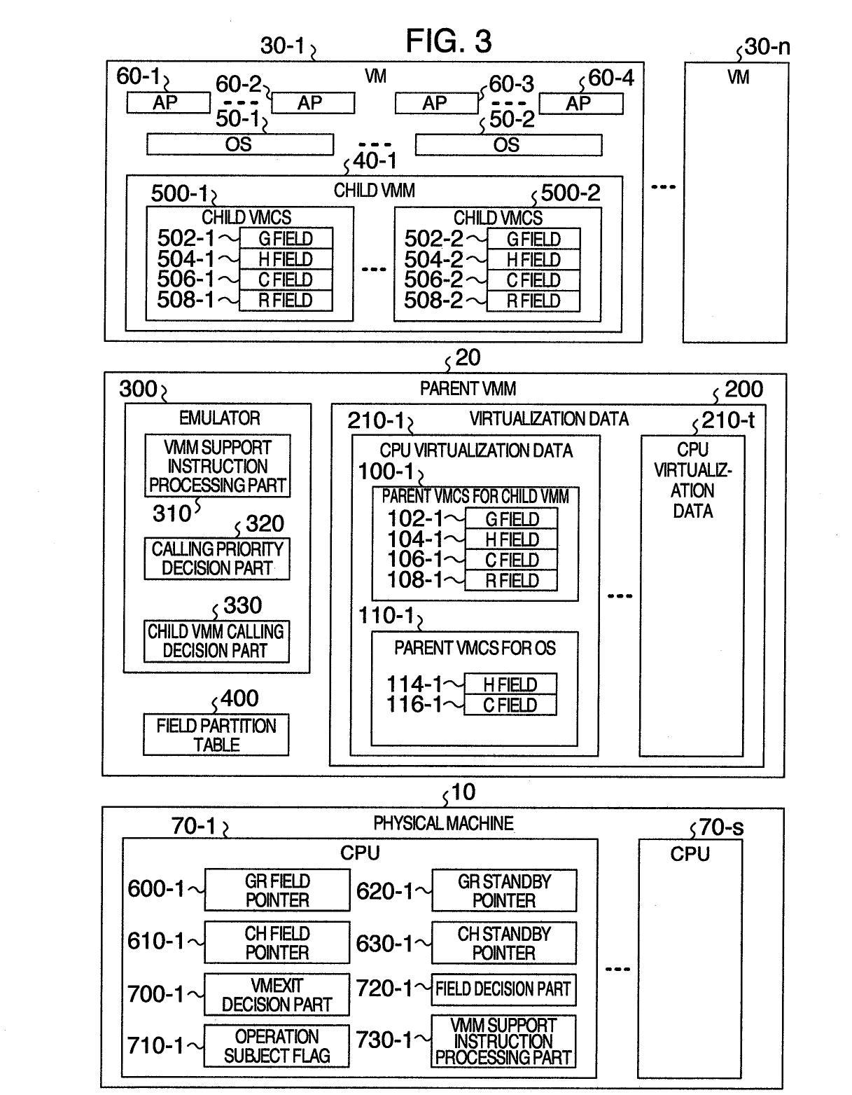

A principal part of a configuration of software which implements the virtual machine 30 on a physical machine 10 and hardware elements which become control objects will now be described in detail with reference to FIG. 3.

At least one CPU 70 is mounted on the physical machine 10. The CPU 70 is a CPU corresponding to the VT function. The CPU 70 operates by referring to VMCS (Virtual Machine Control Structure), which is a data structure for controlling the VT function. According to specifications of the VT function, only one VMCS is activated. In the present embodiment, however, the function of the CPU 70 is expanded to retain VMCS addresses of four kinds which are different in use.

A GR field pointer 600 retains an address of a VMCS including a G (Guest state) field for saving and restoring a state at the time of guest operation and an R (exit Reason) field retaining information of an event which becomes a cause of VMM calling. A CH field pointer 610 retains an address of a VMCS including a C (Condition) field which retains a parent VMM calling condition and an H (Hold state) field which retains an initial state of host operation. A GR standby pointer 620 retains an address of a VMCS including a G field and an R field used to cause the OS 50 and the AP 60 to operate. A CH standby pointer 630 retains an address of a VMCS including a C field and an H field used to cause the OS 50 and the AP 60 to operate.

A VMEXIT decision part 700 monitors operation of the child VMM 40/the OS 50/the AP 60, and makes a decision whether a parent VMM calling condition prescribed in an address retained in the CH field pointer 610 is satisfied. An operation subject flag 710 manages as to which of the parent VMM 20/the child VMM 40/the OS 50/the AP 60 is software operating on the CPU 70. When the child VMM updates a field of the VMCS, a field decision part 720 makes a decision whether the object is a field a note of a change of which should be given to the parent VMM. A VMM support instruction processing part 730 processes instructions, i.e., VMREAD/VMWRITE for referring to/updating the VMCS, VMPTRLD/VMPTRST for registering/referring to an address of the VMCS, VMLAUNCH/VMRESUME for starting/resumption operation of the OS 50 and the AP 60 by using the VMCS, and VMCLEAR for updating the VMCS to the latest state.

The parent VMM 20 which manages at least one virtual machine 30 operates on the physical machine 10. The parent VMM 20 retains an emulator 300 and a field partition table 400. Every virtual CPU assigned to a virtual machine, the parent VMM 20 retains CPU virtualization data 210.

The emulator 300 includes a VMM support instruction processing part 310 for processing a VMM support instruction executed by the child VMM, a calling priority decision part 320 for making a decision which of parent VMM calling and child VMM calling should be given priority when the parent VMM is called, and a child VMM calling decision part 330 for making a decision whether the child VMM calling condition is satisfied. The field partition table 400 is a table which prescribes whether to call the parent VMM when the child VMM updates the VMCS. The CPU virtualization data 210 includes a parent VMCS for child VMM 100 used to cause the child VMM to operate, and a parent VMCS for OS 110 used to cause the OS and the AP to operate. The parent VMCS for child VMM 100 includes all of a G field 102, an H field 104, a C field 106, and an R field 108 of the VMCS. The parent VMCS for OS 110 includes only an H field 114 and a C field 116.

In each virtual machine 30, the child VMM 40 operates. On the child VMM 40, the OS 50 and the AP 60 operate. The child VMM 40 retains a child VMCS 500 for each virtual CPU assigned to the OS 50. The child VMCS 500 includes all of a G field 502, an H field 504, a C field 506 and an R field 508 of the VMCS.

The GR field pointer 600 retains an address of the parent VMCS for child VMM 100 while the child VMM 40 is operating. On the other hand, while the OS 50 and the AP 60 are operating, the GR field pointer 600 retains an address of the child VMCS 500. In other words, operation states of the OS 50 and the AP 60 are saved and restored by using the child VMCS 500 directly.

The CH field pointer 610 retains an address of the parent VMCS for child VMM 100 while the child VMM 40 is operating. On the other hand, while the OS 50 and the AP 60 are operating, the CH field pointer 610 retains an address of the parent VMCS for OS 110. In other words, as for the parent VMM calling condition (parent VMEXIT condition) applied while the OS 50 and the AP 60 are operating, the C field of not the child VMCS 500 but the parent VMCS for OS 110 is applied.

The GR standby pointer 620 always retains an address of the child VMCS 500. When the operation subject changes from the child VMM 40 to the OS 50/AP 60, the GR standby pointer 620 supplies the address of the child VMCS 500 to the GR field pointer 600.

The CH standby pointer 630 always retains an address of the parent VMCS for OS 110. When the operation subject changes from the child VMM 40 to the OS 50/AP 60, the CH standby pointer 630 supplies the address of the parent VMCS for OS 110 to the CH field pointer 610.

The H field 104 of the parent VMCS for child VMM 100, the C field 106 (a fourth data structure) of the parent VMCS for child VMM 100, and the H field 114 of the parent VMCS for OS 110 retain individual setting of the parent VMM. The C field 116 (a second data structure) of the parent VMCS for OS 110 includes all of events which become the child VMM calling condition prescribed in the C field 506 (a first data structure) of the child VMCS.

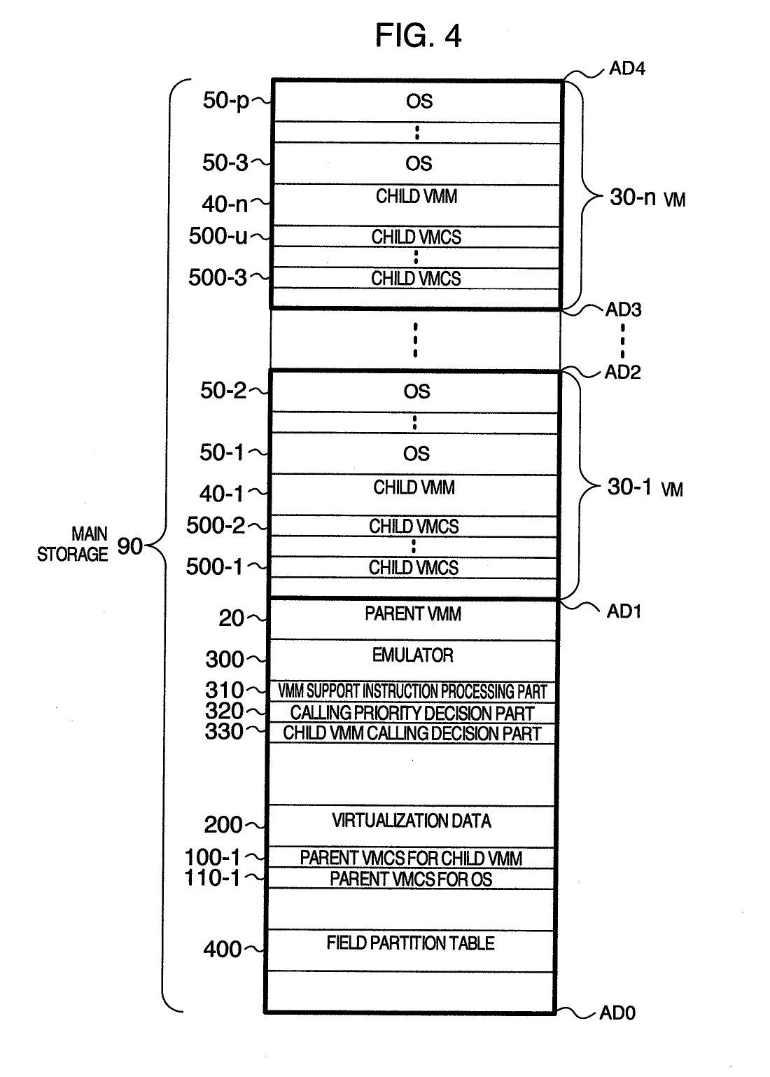

FIG. 4 shows an example of the main storage 90 managed by the parent VMM 20. The parent VMM 20 assigns an area where itself is disposed and an area to be used by the virtual machine 30 to the main storage 90. For example, as shown in FIG. 4, the parent VMM 20 assigns addresses AD0 to AD1 to itself, assigns addresses AD1 to AD2 to the virtual machine 30-1, and assigns addresses AD3 to AD4 to the virtual machine 30-n.

The emulator 300, the virtualization data 200 and the field partition table 400 are assigned to the area to be used by the parent VMM 20. The emulator 300 includes the VMM support instruction processing part 310, the calling priority decision part 320, and the child VMM calling decision part 330. The virtualization data 200 includes the parent VMCS for child VMM 100 and the parent VMCS for OS 110.

The child VMM 40 and the OS 50 are included in the area of each virtual machine 30. The child VMM 40 uses a part of the memory area as the child VMCS 500.

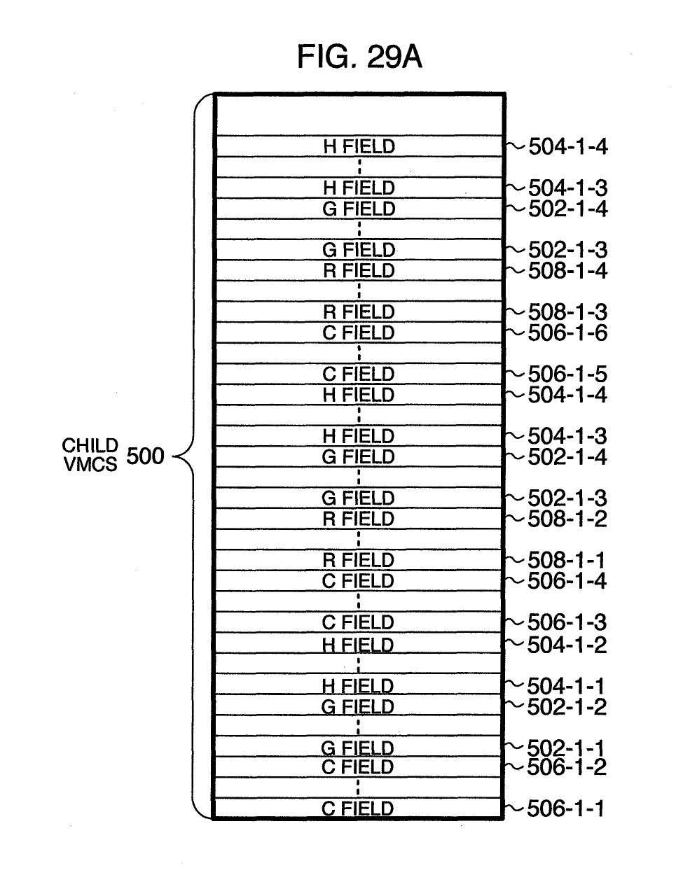

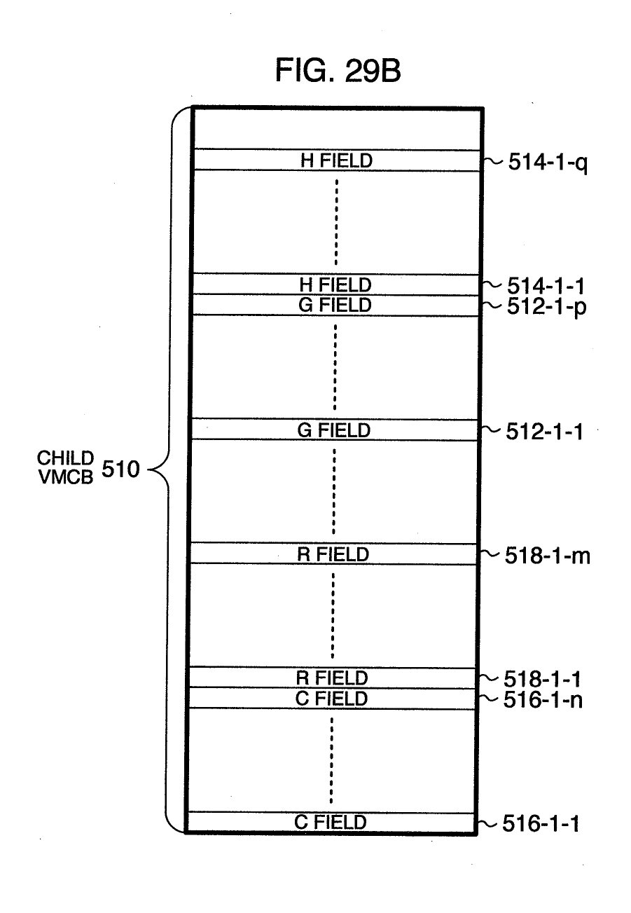

FIG. 29A shows a format of the child VMCS 500. The VMCS has a size of 4 KB. A large number of fields each having a size in the range of 2 to 8 bytes are mixedly present in the 4 KB. The parent VMCS for child VMM 100 also has the same format. As for the parent VMCS for OS 110, the format is the same although the G field and the R field are not used.

In a memory protection mechanism of the x86 CPU, the condition of calling the parent VMM 20 can be prescribed only by taking 4 KB as the unit. For executing different update processing every field like in the present invention, it is necessary to specify the calling condition of the parent VMM by taking a size less than 4 KB as the unit. In the present embodiment, the field partition table 400 and the field decision part 720 are used to prescribe whether the calling of the parent VMM 20 is required every field having a size of several bytes.

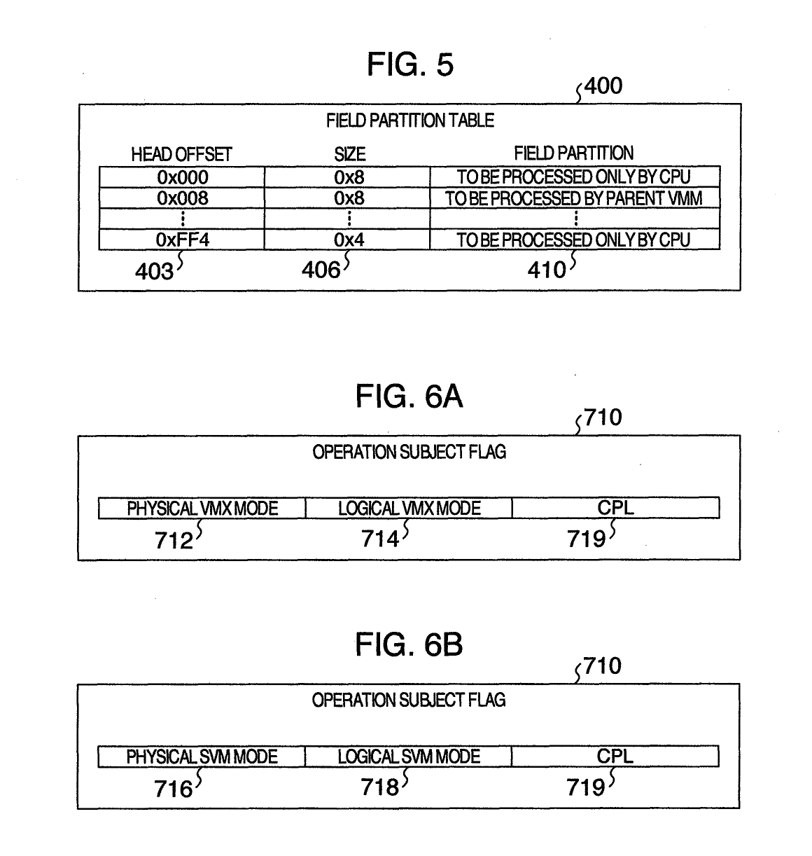

FIG. 5 shows an example of a configuration diagram of the field partition table 400. The field partition table 400 associates each of fields in the VMCS formed of a 4-KB memory with whether calling of the parent VMM 20 is required when the field is updated. Whether calling of the parent VMM 20 is required when the field is updated is referred to as field partition 410. In the present example, each area formed of a head offset 403 and a size 406 in the VMCS is associated with the field partition 410 as a way of retaining data.

The head offset 403 is a value obtained by subtracting a head address of a field from a head address of the VMCS. As regards consecutive fields having the same field partition 410, the size 406 retains the sum total of the field sizes by taking byte as the unit. As for the way of retaining data, it is a matter of course that implementation of specifying the field partition 410 every byte is conceivable. In the first embodiment, the field partition table is generated so as to cause the parent VMM to process only the C field of the VMCS and cause only the CPU to process the G field/H field/R field.

FIG. 6A is a configuration diagram of the operation subject flag 710. The operation subject flag includes a physical VMX mode 712, a logical VMX mode 714, and a CPL 719. If the operation subject is the VMM 20, the physical VMX mode 712 retains “root.” If the operation subject is the child VMM 40/OS 50/AP 60, the physical VMX mode 712 retains “non-root.” The logical VMX mode 714 is used only in the case where the physical VMX mode 712 is “non-root.” If the operation subject is the child VMM 40, the logical VMX mode 714 retains “root.” If the operation subject is the OS 50/AP 60, the logical VMX mode 714 retains “non-root.” The CPL 719 is used only in the case where both the physical VMX mode 712 and the logical VMX mode 714 are “non-root.” If the operation subject is the OS 50, the CPL 719 retains 0. If the operation subject is the AP 60, the CPL 719 retains 3.

By the way, the VMX (Virtual-Machine eXtentions) mode is a state of the CPU prescribed in specifications of the virtualization support mechanism (VT-x) of Intel Corporation. If the VMX mode is “root,” a VMX dedicated instruction can be executed and the CPU does not monitor software operation. If the VMX mode is “non-root,” the VMM dedicated instruction cannot be executed and the CPU monitors the software operation.

The CPL (Current Privilege Level) is a privilege level of the CPU prescribed in architecture specifications of the x86 CPU. The CPL has a value region of 0 to 3, in which 0 is the highest privilege level. When the CPL is 0, all operations to hardware are allowed. The CPL of 3 is the lowest privilege level, at which hardware operation is limited greatly. Usually, only 0 and 3 are used. At the time of OS operation, the CPL becomes 0. At the time of operation of an application (general program), the CPL becomes 3.

### <3. Virtualization Processing Conducted by Parent VMM and CPU>

Hereafter, an example of virtualization processing conducted by the parent VMM 20 and the CPU 70 according to operation of the child VMM 40/OS 50/AP 60 will be described with reference to flow charts.

### <3.1 Outline of Virtualization Processing Conducted by Parent VMM and CPU>

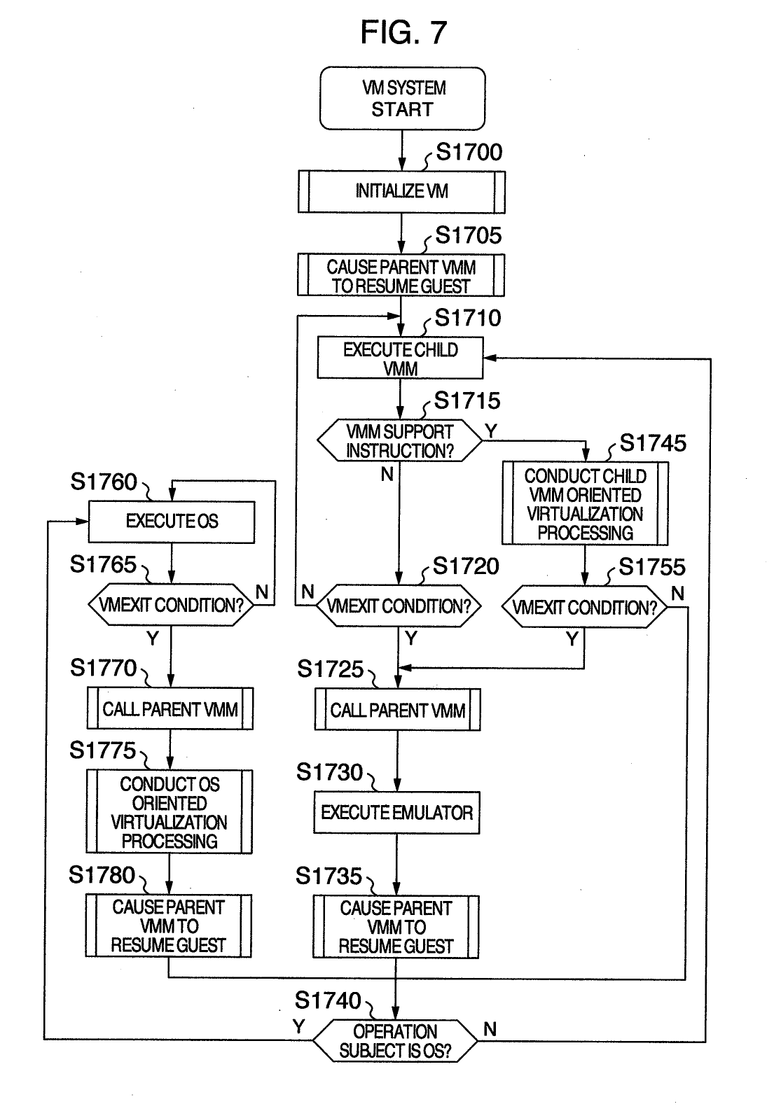

FIG. 7 is a flow chart showing general processing conducted when executing the child VMM 40/OS 50/AP 60 on the parent VMM 20. The present flow chart is premised on utilization by a plurality of CPUs 70. Each CPU 70 operates independently according to the present flow chart.

At S1700, the parent VMM 20 generates the parent VMCS for child VMM 100, and makes preparations for causing the child VMM 40 to operate on the virtual machine 30.

At S1705, the parent VMM 20 conducts operation resumption processing of the guest (the child VMM 40/OS 50/AP 60). Since the virtual machine 30 is already initialized so as to cause the child VMM 40 to operate, operation of the child VMM 40 is started by the present processing.

At S1710, the CPU 70 executes an instruction of the child VMM 40.

At S1715, the CPU 70 makes a decision whether the child VMM 40 has executed a VMM support instruction such as VMRESUME. If the child VMM 40 has executed a VMM support instruction, the processing proceeds to S1745. Otherwise, the processing proceeds to S1720.

At S1720, the CPU 70 refers to the CH field pointer 610, and makes a decision whether an event prescribed in the C field 106 (the fourth data structure prescribing an event which becomes a condition of calling the parent VMM during operation of the child VMM) of the parent VMCS for child VMM has occurred. If the event has occurred, the processing proceeds to S1725. Otherwise, the processing proceeds to S1710.

At S1725, the CPU 70 saves the CPU state, and calls the parent VMM 20.

At S1730, the parent VMM 20 emulates behavior of a machine according to an event which has occurred in the child VMM 40, and updates the state of the virtual machine 30.

At S1735, the parent VMM 20 releases the CPU 70, and resumes the guest operation.

At S1740, the operation subject of the resumed guest is judged. If the operation subject is the OS 50 or the AP 60, the processing proceeds to S1760. If the operation subject is the child VMM, the processing proceeds to S1710.

At S1745, the parent VMM 20 or the CPU 70 conducts virtualization processing according to the VMM support instruction executed by the child VMM 40.

At S1755, a decision is made whether an event prescribed in the C field 106 of the parent VMCS for child VMM has occurred as a result of virtualization processing conducted at S1745. If the event has occurred, the processing proceeds to S1725. Otherwise, the processing proceeds to S1740.

At S1760, the CPU 70 executes an instruction of the OS 50 or the AP 60.

At S1765, the CPU 70 refers to the CH field pointer 610, and makes a decision whether an event prescribed in the C field 116 (the second data structure prescribing an event which becomes a condition of calling the parent VMM during operation of the OS) of the parent VMCS for OS has occurred. If the event has occurred, the processing proceeds to S1770. Otherwise, the processing proceeds to S1760.

At S1770, the CPU 70 saves the CPU state, and calls the parent VMM 20.

At S1775, the parent VMM 20 emulates behavior of a machine according to the event, and updates the state of the virtual machine 30.

At S1780, the parent VMM 20 releases the CPU 70, and resumes the guest operation.

### <3.2 Initialization Processing>

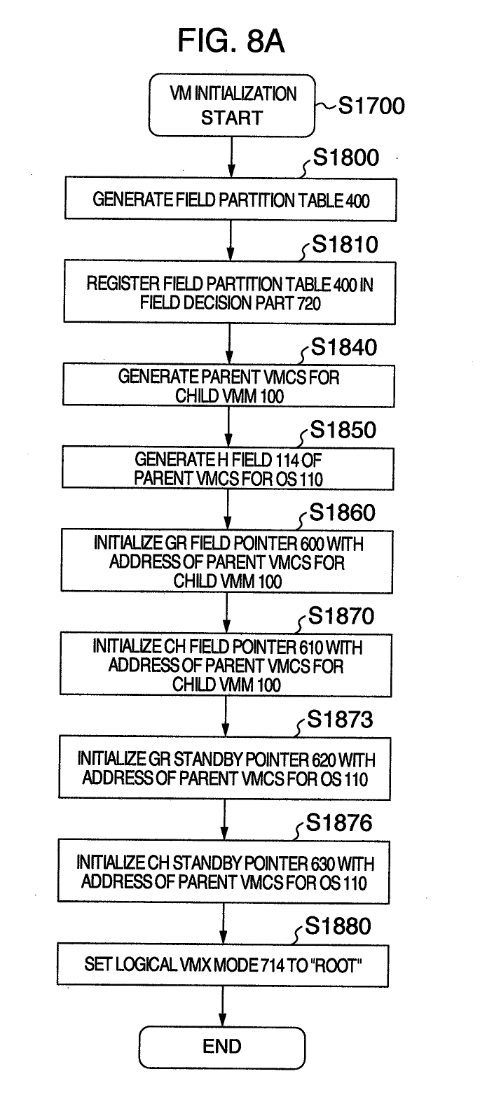

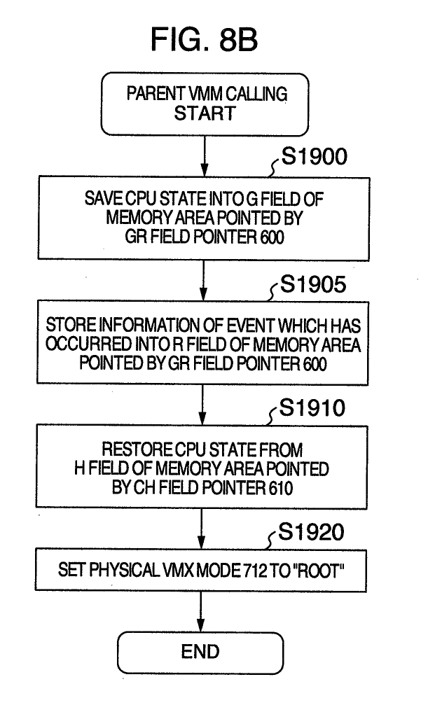

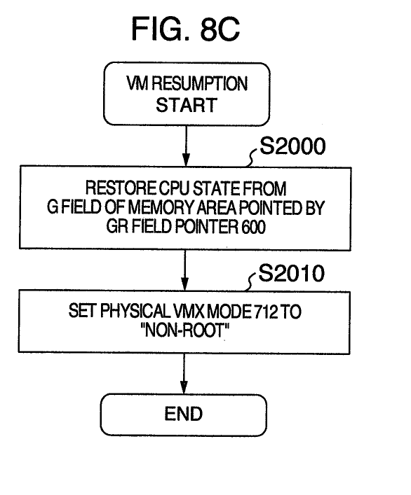

The initialization processing of the virtual machine conducted at S1700 in FIG. 7 will now be described with reference to FIG. 8A.

At S1800, the parent VMM 20 secures a memory area where the field partition table 400 is to be disposed. In the case of the C field, the parent VMM 20 sets whether the parent VMM calling is required every field to “required.” In the case of the G/R/H field, the parent VMM 20 sets whether the parent VMM calling is required every field to “not required.”

At S1810, the parent VMM 20 delivers an address of the memory where the field partition table 400 is disposed to the CPU 70, and initializes the field decision part 720.

At S1840, the parent VMM 20 secures a memory area where the parent VMCS for child VMM 100 is to be disposed, and sets a value of the initial state of the x86 CPU into the G field 102. The parent VMM 20 sets values required for operation of the parent VMM 20 into the H field 104 and the C field 106.

At S1850, the parent VMM 20 secures a memory area where the parent VMCS for OS 110 is to be disposed, and sets a value required for operation of the parent VMM 20 into the H field 114.

At S1860, the parent VMM 20 stores an address of the parent VMCS for child VMM 100 into the GR field pointer 600, and activates the parent VMCS for child VMM 100.

At S1870, the parent VMM 20 stores the address of the parent VMCS for child VMM 100 into the CH field pointer 610, and activates the parent VMCS for child VMM 100.

At S1873, the parent VMM 20 stores an address of the parent VMCS for OS 110 into the GR standby pointer 620.

At S1876, the parent VMM 20 stores the address of the parent VMCS for OS 110 into the CH standby pointer 630.

At S1880, the parent VMM 20 sets “root” into the logical VMX mode 714 to cause the operation subject to be recognized as the child VMM 40 when the physical VMX mode 712 has become “non-root.”

### <3.3 Parent VMM Calling Processing>

The parent VMM calling processing conducted at S1725 and S1770 shown in FIG. 7 will now be described with reference to FIG. 8B.

At S1900, the CPU 70 saves the CPU state into the G field of the VMCS pointed by the GR field pointer 600. While the child VMM 40 is operating, the GR field pointer 600 points the parent VMCS for child VMM 100 and consequently the CPU state is saved into the G field 102 (a fifth data structure) of the parent VMCS for child VMM. On the other hand, while the OS 50/AP 60 is operating, the GR field pointer 600 points the child VMCS 500 and consequently the CPU state is saved into the G field 502 (a third data structure which becomes a saving/restoration destination of the CPU state when interrupting and resuming the OS) of the child VMCS.

At S1905, the CPU 70 stores information of an event which has become the cause of calling the parent VMM 20 into the R field of the VMCS pointed by the GR field pointer 600.

At S1910, the CPU 70 restores the CPU state from the H field of the VMCS pointed by the CH field pointer 610. While the child VMM 40 is operating, the CH field pointer 610 points the parent VMCS for child VMM 100 and consequently the CPU state is restored from the H field 104 of the parent VMCS for child VMM. On the other hand, while the OS 50/AP 60 is operating, the CH field pointer 610 points the parent VMCS for OS 110 and consequently the CPU state is restored from the H field 114 of the parent VMCS for OS.

At S1920, the CPU 70 sets the physical VMX mode 712 to “root” and changes over the operation subject to the parent VMM 20.

### <3.4 Guest Resumption Processing>

The guest resumption processing conducted at S1705, S1735 and S1780 shown in FIG. 7 will now be described with reference to FIG. 8C.

At S2000, the parent VMM 20 restores the CPU state from the G field of the VMCS pointed by the GR field pointer 600. When resuming the child VMM 40, the GR field pointer 600 points the parent VMCS for child VMM 100 and consequently the CPU state is restored from the G field 102 (the fifth data structure which becomes the saving/restoration destination of the CPU state when interrupting and resuming the VMM) of the parent VMCS for child VMM. On the other hand, when resuming the OS 50/AP 60, the GR field pointer 600 points the child VMCS 500, and consequently the CPU state is restored from the G field 502 of the child VMCS.

At S2010, the parent VMM 20 sets the physical VMX mode 712 to “non-root” and changes over the operation subject to one of the child VMM40/OS 50/AP 60 according to the combination of the logical VMX mode 714 and the CPL 719.

### <3.5 OS-Oriented Processing>

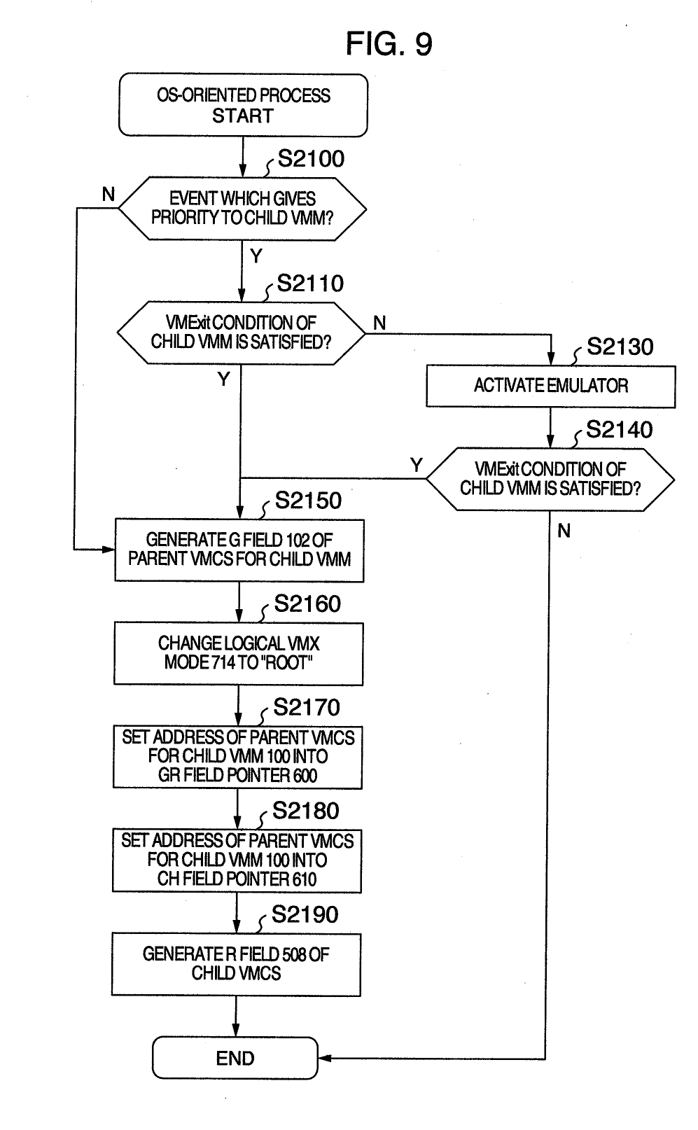

OS-oriented processing conducted at S1775 shown in FIG. 7 will now be described with reference to FIG. 9.

At S2100, the parent VMM 20 refers to the R field of the VMCS pointed by the GR field pointer 600, and grasps the event which has occurred. Then, the calling priority decision part 320 in the parent VMM 20 makes a decision whether to give priority to processing in the child VMM 40 or give priority to processing in the parent VMM 20 according to the kind of the event which has occurred. If the event which has occurred is an interrupt generated in synchronism with instruction execution of the OS 50, such as page fault, the processing in the child VMM 40 is judged in the present procedure to be given priority. On the other hand, if the event is an interrupt which is not in synchronism with instruction execution of the OS 50, such as an interrupt of the I/O interface 850 or the like, the processing in the parent VMM 20 is judged to be given priority. If the processing in the child VMM 40 is given priority, the processing proceeds to S2110. If the processing in the parent VMM 20 is given priority, the processing proceeds to S2150.

At S2110, the child VMM calling decision part 330 in the parent VMM 20 collates the event which has occurred with the C field 506 (the first data structure prescribing an event which becomes a condition of calling the child VMM during operation of the OS) of the child VMCS pointed by the GR field pointer 600, and makes a decision whether the condition of calling the child VMM 40 is satisfied. If the condition of calling the child VMM 40 is satisfied, the processing proceeds to S2150. Otherwise, the processing proceeds to S2130.

At S2130, the parent VMM 20 conducts emulation on the behavior of the machine according to the event, and updates the state of the virtual machine 30.

At S2140, the parent VMM 20 makes a decision whether the event prescribed in the C field 506 of the child VMCS has occurred as a result of the processing conducted at S2130. If the event has occurred, the processing proceeds to S2150. Otherwise, the present procedure is finished.

At S2150, the parent VMM 20 refers to the H field 504 of the child VMCS pointed by the GR field pointer 600, and copies it into the G field 102 of the parent VMCS for child VMM. As a result of the present processing, a setting value in the H field 504 of the child VMCS which retains the initial state of the child VMM 40 is reflected to the CPU.

At S2160, the parent VMM 20 changes the logical VMX mode 714 to “root” to cause the operation subject to be recognized as the child VMM 40 when resuming the guest next time.

At S2170, the GR field pointer 600 is caused to retain the address of the parent VMCS for child VMM 100 to prepare for resumption of the child VMM 40.

At S2180, the CH field pointer 610 is caused to retain the address of the parent VMCS for child VMM 100 to prepare for resumption of the child VMM 40.

At S2190, the parent VMM 20 generates the R field 508 of the child VMCS. If the event which has called the parent VMM 20 coincides with the event which becomes a cause of calling the child VMM 40, there is no processing to be conducted in the present procedure because the CPU stores information of the event in the R field 508 of the child VMCS when the parent VMM 20 is called. On the other hand, if the event which has called the parent VMM 20 does not coincide with the event which becomes the cause of calling the child VMM 40, the parent VMM 20 overwrites information of the event.

### <3.6 Child VMM-Oriented Processing>

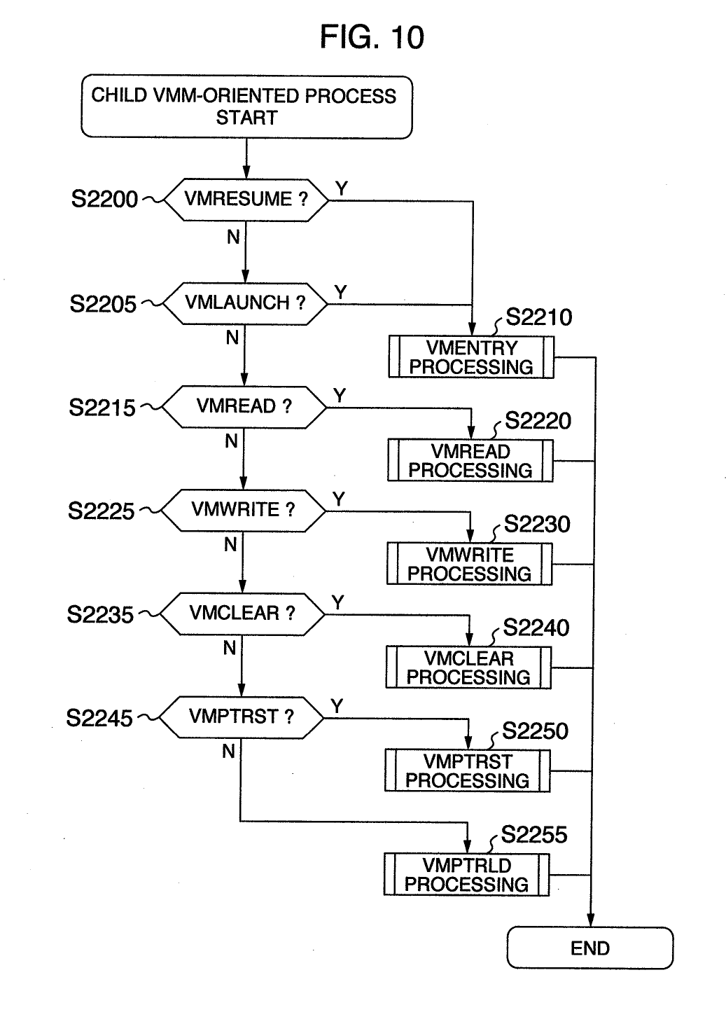

The child VMM-oriented processing conducted at S1745 shown in FIG. 7 will now be described with reference to FIG. 10.

At S2200, the CPU 70 makes a decision whether the executed instruction is VMRESUME which is a resumption instruction of the OS 50/AP 60. If the executed instruction is VMRESUME, the processing proceeds to S2210. Otherwise, the processing proceeds to S2205.

At S2205, the CPU 70 makes a decision whether the executed instruction is VMLAUNCH which is a start instruction of the OS 50/AP 60. If the executed instruction is VMLAUNCH, the processing proceeds to S2210. Otherwise, the processing proceeds to S2215.

At S2210, the parent VMM 20 or the CPU 70 conducts processing for changing over the GR field pointer and the CH field pointer to resume the OS 50/AP 60.

At S2215, the CPU 70 makes a decision whether the executed instruction is a VMREAD instruction for referring to a field in the child VMCS 500. If the executed instruction is VMREAD, the processing proceeds to S2220. Otherwise, the processing proceeds to S2225.

At S2220, the CPU 70 reads out the pertinent field of the child VMCS 500 pointed by the GR standby pointer 620, and stores it into a register or the memory according to a parameter of the VMREAD instruction.

At S2225, the CPU 70 makes a decision whether the executed instruction is a VMWRITE instruction which updates a field in the child VMCS 500. If the executed instruction is the VMWRITE instruction, the processing proceeds to S2230. Otherwise, the processing proceeds to S2235.

At S2230, the CPU 70 updates the pertinent field of the child VMCS 500 pointed by the GR standby pointer 620. Furthermore, the CPU 70 updates the C field 106 of the parent VMCS for child VMM as occasion demands, and adds execution of the VMLAUNCH and VMRESUME instructions to the parent VMM 20 calling condition.

At S2235, the CPU 70 makes a decision whether the executed instruction is VMCLEAR which updates the child VMCS 500 to the latest state. If the executed instruction is VMCLEAR, the processing proceeds to S2240. Otherwise, the processing proceeds to S2245.

At S2240, the CPU 70 reflects all data reserved in writing to the memory as regards the child VMCS 500 specified by an instruction parameter, if any, to the memory, and updates the child VMCS to the latest state.

At S2245, the CPU 70 makes a decision whether the executed instruction is VMPTRST, which refers to an address of the active child VMCS 500. If the executed instruction is VMPTRST, the processing proceeds to S2250. Otherwise, the processing proceeds to S2255.

At S2250, the CPU 70 reads out the GR standby pointer 620, and stores it into a register or the memory according to a parameter of the VMPTRST instruction.

At S2255, the parent VMM 20 conducts update of the child VMCS 500, update of the parent VMCS for OS 110, and update of the GR standby pointer 620 in accordance with inactivation/activation of the child VMCS 500 caused by execution of the VMPTRLD.

### <3.7. VMENTRY Processing>

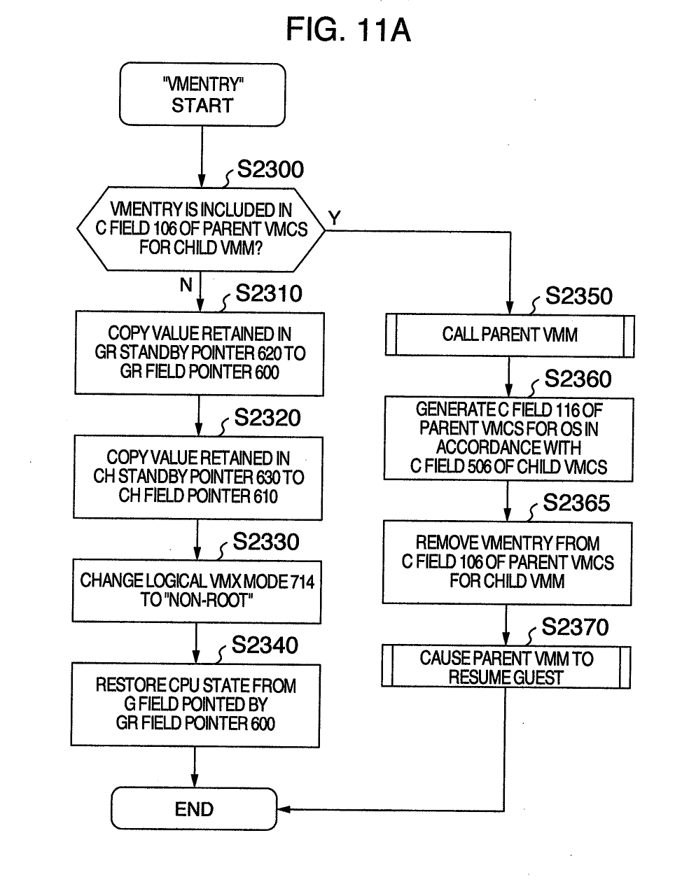

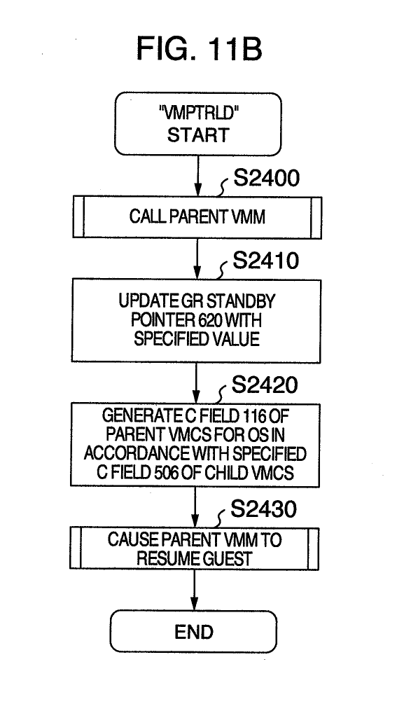

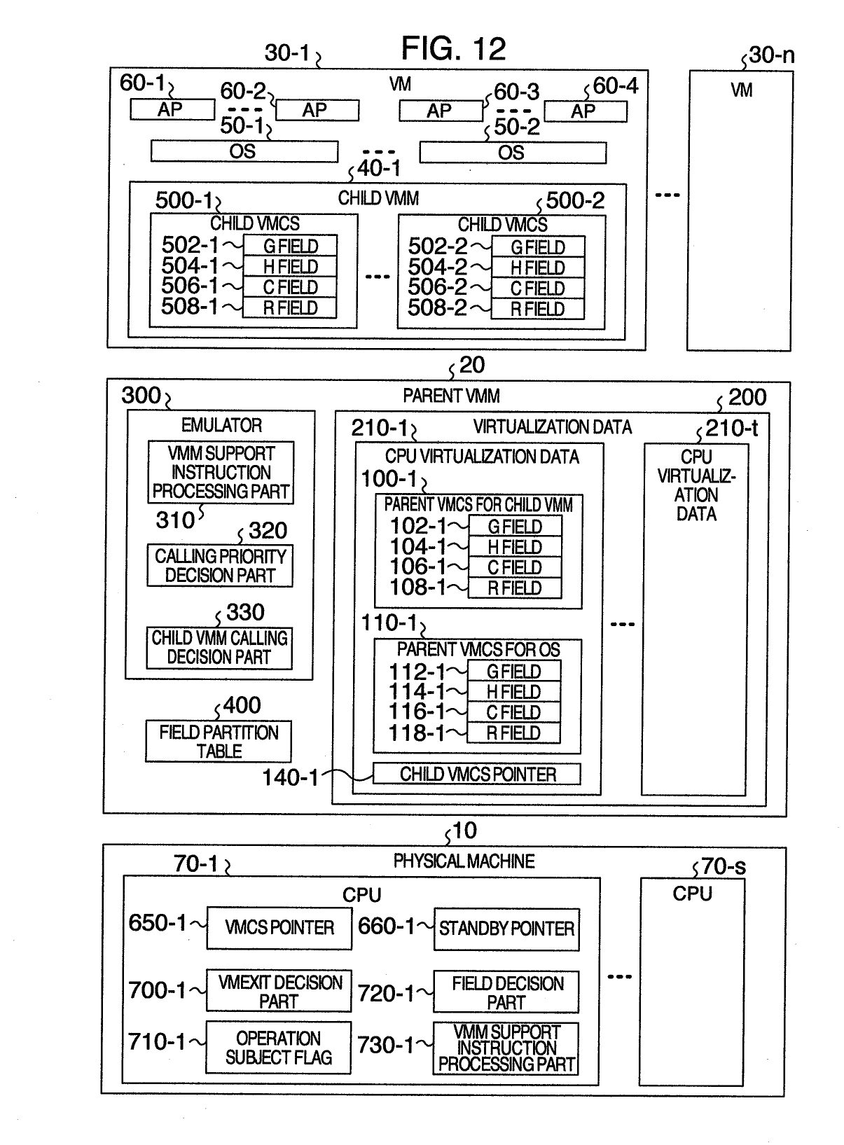

VMENTRY processing conducted at S2210 shown in FIG. 10 will now be described with reference to FIG. 11A.

VMENTRY is a general term of the VMLAUNCH/VMRESUME instruction which starts/resumes the guest operation. In the present processing, changeover of a pointer for causing the OS/AP to operate is conducted. If the C field of the child VMCS is already updated, the parent VMCS for OS corresponding to the child VMCS after the update is prepared prior to the pointer changeover.

At S2300, the CPU 70 refers to the CH field pointer 610, and makes a decision whether execution of the VMLAUNCH/VMRESUME by the child VMM is included in the parent VMM calling condition in the C field 106 of the parent VMCS for child VMM. If included, the C field 516 of the child VMCS is already updated and consequently the processing proceeds to S2350. Otherwise, the processing proceeds to S2310.

At S2310, the CPU 70 reads out the value of the GR standby pointer 620, copies the value into the GR field pointer 600, and prepares for resumption of the OS 50/AP 60.

At S2320, the CPU 70 reads out the value of the CH standby pointer 630, copies the value into the CH field pointer 610, and prepares for resumption of the OS 50/AP 60.

At S2330, the CPU 70 changes the logical VMX mode 714 to “non-root” and changes over the operation subject to the OS 50 or the AP 60 according to the CPL 719.

At S2340, the CPU 70 refers to the GR field pointer 600, and restores the CPU state from the G field 502 of the child VMCS.

At S2350, the CPU 70 calls the parent VMM 20.

At S2360, the parent VMM 20 refers to the C field 506 of the child VMCS on the basis of a value retained in the GR standby pointer 620, and updates the C field 116 of the parent VMCS for OS so as to include all events included in the C field 506 of the child VMCS.

At S2365, the parent VMM 20 removes execution of VMLAUNCH/VMRESUME by child VMM from the parent VMM calling condition in the C field 106 of the parent VMCS for child VMM.

At S2370, the parent VMM 20 releases the CPU 70 and causes the child VMM 40 to re-execute VMENTRY.

### <3.8. VMWRITE Processing>

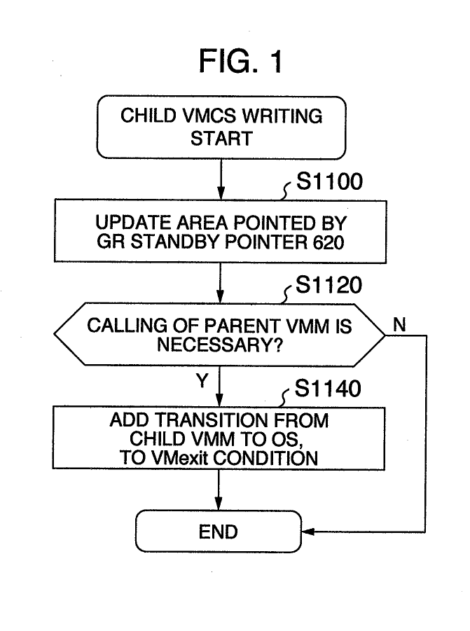

The VMWRITE processing conducted at S2220 shown in FIG. 10 will now be described with reference to FIG. 1.

At S1100, the CPU 70 acquires an address of the child VMCS 500 by referring to the GR standby pointer 620, and updates a field specified by a parameter of VMWRITE.

At S1120, the field decision part 720 refers to the field partition table 400 by using an offset of the updated field, and finds the field partition 410 corresponding to a head offset 403 of an area including the offset and a size 406 of the area. If the field partition 410 indicates “to be processed by parent VMM,” calling of the parent VMM 20 is judged to be necessary and the processing proceeds to S1140. If the field partition 410 indicates “to be processed only by CPU,” calling of the parent VMM 20 is judged to be unnecessary and the present processing is finished.

At S1140, the CPU 70 acquires an address of the parent VMCS for child VMM by referring to the CH field pointer 610, and adds execution of VMLAUNCH/VMRESUME by the child VMM 40 to the C field 106 of the parent VMCS for child VMM which prescribes an event calling the parent VMM 20.

### <3.9. VMPTRLD Processing>

The VMPTRLD processing conducted at S2255 shown in FIG. 10 will now be described with reference to FIG. 11B. In the present processing, the parent VMCS for OS corresponding to the child VMCS after the changeover is prepared.

At S2400, the CPU 70 calls the parent VMM 20.

At S2410, the parent VMM 20 copies a parameter of the VMPTRLD instruction into the GR standby pointer 620.

At S2420, the C field 116 of the parent VMCS for OS is updated so as to include all of events included in the C field 506 of the child VMCS specified by the parameter of the VMPTRLD instruction and events included in the C field 106 of the parent VMCS for child VMM.

At S2430, the parent VMM 20 releases the CPU 70 and causes the guest operation to be resumed.

### <4. Summary>

According to the embodiment described heretofore, update contents of the G field update of the child VMCS which is high in frequency are reflected directly to the child VMCS, and the pointer in the CPU is replaced for subsequent VMENTRY. Since calling of the parent VMM which causes performance degradation can be avoided owing to the processing described heretofore, fast update and VMENTRY can be implemented. On the other hand, if the C field is updated, then the parent VMM prepares the corresponding parent VMCS for OS with subsequent VMENTRY as a momentum, and consequently the VT function based on specifications can be given to the child VMM. Furthermore, since the function of the CPU is expanded only for the G field, the increase of the semiconductor quantity and power dissipation of the CPU can also be suppressed.

### Second Embodiment

Hereafter, an embodiment in which the child VMM is caused to utilize the VT function and the G field of the parent VMCS for OS is also used for the G field of the child VMCS, as a common memory area will be described. In the present embodiment, update of the child VMCS conducted by the child VMM is reflected to the parent VMCS for OS instantly. Furthermore, the R field of the parent VMCS for OS is also used for the R field of the child VMCS, as a common memory area. Hereafter, a difference from the first embodiment will be described with reference to accompanying drawings.

### <1. Hardware Configuration>

FIG. 2 shows a configuration of a physical machine which causes a two-level virtual machine system to operate in the second embodiment of the present invention. Since the configuration is the same as that in the first embodiment, its description will be omitted.

### <2. Software Configuration>

A principal part of a configuration of software which implements the virtual machine 30 on the physical machine 10 and hardware elements which become control objects will now be described in detail with reference to FIG. 12.

As regards the CPU 70 mounted on the physical machine 10, only a VMCS pointer 650 and a standby pointer 660 differ from the first embodiment. In the present embodiment, the function of the CPU 70 is expanded to retain addresses of two kinds of VMCS which differ in use. The VMCS pointer 650 retains an address of an active VMCS. The standby pointer 660 retains an address of a VMCS to be used when causing the OS 50 and AP 60 to operate. The VMEXIT decision part 700 monitors operation of the child VMM 40/the OS 50/the AP 60, and makes a decision whether a parent VMM calling condition prescribed in an address retained in the VMCS pointer 650 is satisfied.

As regards the parent VMM 20 operating on the physical machine 10, only the parent VMCS for OS 110, a child VMCS pointer 140, and the field partition table 400 differ from the first embodiment. The parent VMCS for OS 110 includes all of a G field 112 (a sixth data structure), an H field 114, a C field 116, and an R field 118 of the VMCS. The field partition table 400 is a table which prescribes whether to call the parent VMM when the child VMM refers to/updates the VMCS. Each virtual machine 30 is the same as that in the first embodiment.

The VMCS pointer 650 retains an address of the parent VMCS for child VMM 100 while the child VMM 40 is operating. On the other hand, while the OS 50 and the AP 60 are operating, the VMCS pointer 650 retains an address of the parent VMCS for OS 110. In other words, the operation state of the OS 50 and the AP 60 is saved and restored by using the parent VMCS for OS 110.

The standby pointer 660 always retains an address of the parent VMCS for OS. When the operation subject changes from the child VMM 40 to the OS 50/AP 60, the standby pointer 660 supplies the address of the parent VMCS for OS to the VMCS pointer 650.

The G field 112 of the parent VMCS for OS and the R field 118 of the parent VMCS for OS are used as temporary copies of the G field 502 of the child VMCS and the R field 508 of the child VMCS, and are synchronized with the G field 502 of the child VMCS and the R field 508 of the child VMCS.

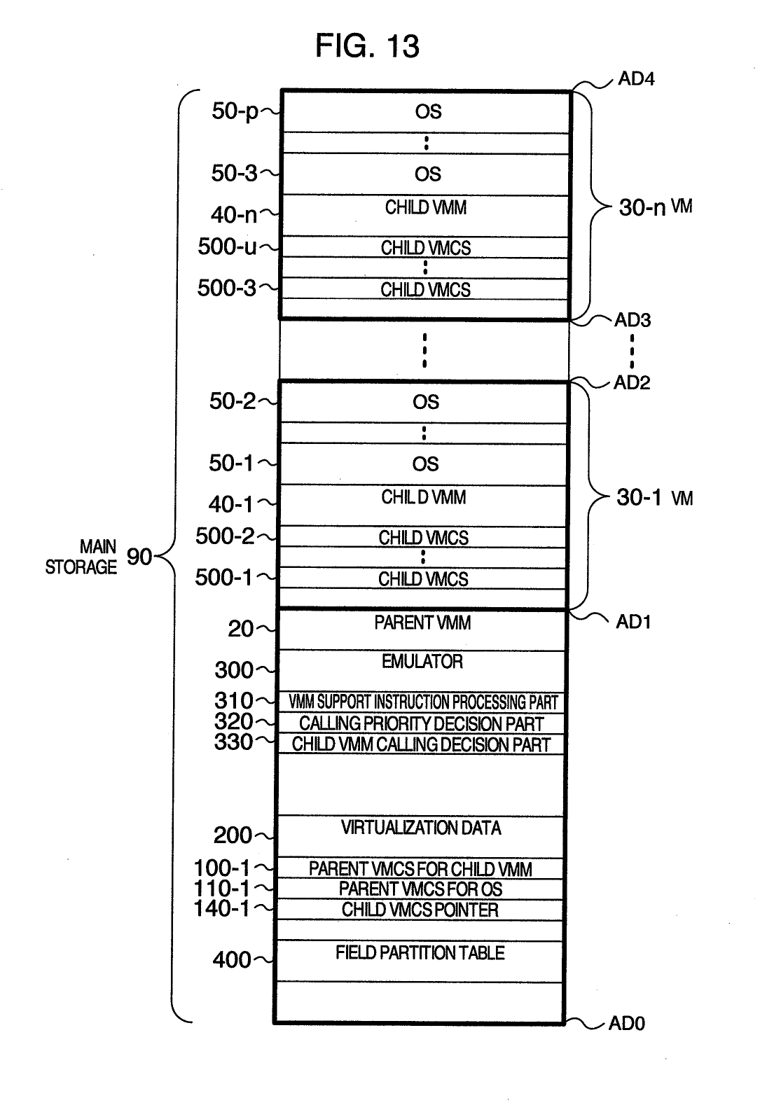

FIG. 13 shows an example of the main storage 90 managed by the parent VMM 20. FIG. 13 differs from the first embodiment only in the child VMCS pointer 140. The virtualization data 200 includes the parent VMCS for child VMM 100, the parent VMCS for OS 110, and the child VMCS pointer 140.

FIG. 29A shows a format of the child VMCS 500. Since it is the same as that in the first embodiment, its description will be omitted.

FIG. 5 shows an example of a configuration diagram of the field partition table 400. Since the field partition table 400 has the same configuration as that in the first embodiment, its description will be omitted. In the second embodiment, the field partition 410 prescribes whether parent VMM calling is necessary as regards not only field update but also field reference. Furthermore, in the second embodiment, the field partition 410 is generated so as to cause the parent VMM to process the C field and the H field of the VMCS and cause only the CPU to process the G field and the R field.

FIG. 6A is a configuration diagram of the operation subject flag 710. Since the configuration diagram is the same as that in the first embodiment, its description will be omitted.

### <3. Virtualization Processing Conducted by Parent VMM and CPU>

Hereafter, an example of virtualization processing conducted by the parent VMM 20 and the CPU 70 according to the operation of the child VMM 40/OS 50/AP 60 will be described with reference to flow charts.

### <3.1. Outline of Virtualization Processing Conducted by Parent VMM and CPU>

FIG. 7 is a flow chart showing general processing conducted when executing the child VMM 40/OS 50/AP 60 on the parent VMM 20. The present flow chart differs from that in the first embodiment only in S1720 and S1765.

At S1720, the CPU 70 refers to the VMCS pointer 650, and makes a decision whether an event prescribed in the C field 106 (a fourth data structure prescribing an event which becomes a condition of calling the parent VMM during operation of the child VMM) of the parent VMCS for child VMM has occurred. If the event has occurred, the processing proceeds to S1725. Otherwise, the processing proceeds to S1710.

At S1765, the CPU 70 refers to the VMCS pointer 650, and makes a decision whether an event prescribed in the C field 116 (a second data structure prescribing an event which becomes a condition of calling the child VMM during operation of the OS) of the parent VMCS for OS has occurred on the CPU 70. If the event has occurred, the processing proceeds to S1770. Otherwise, the processing proceeds to S1760.

### <3.2. Initialization Processing>

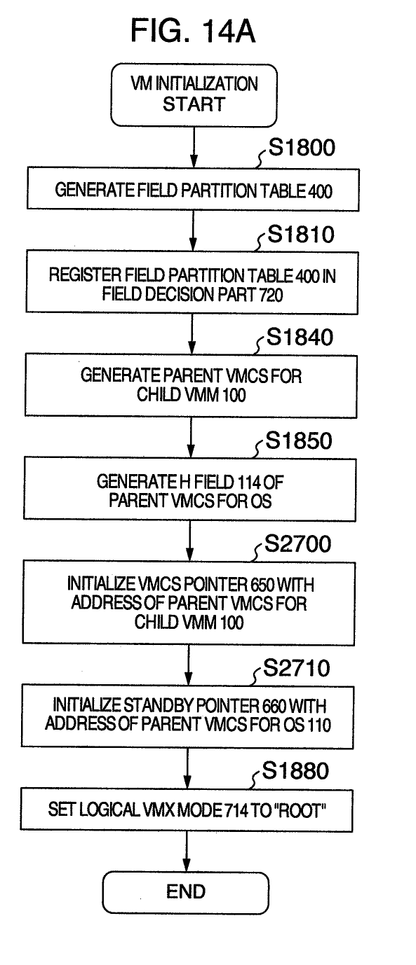

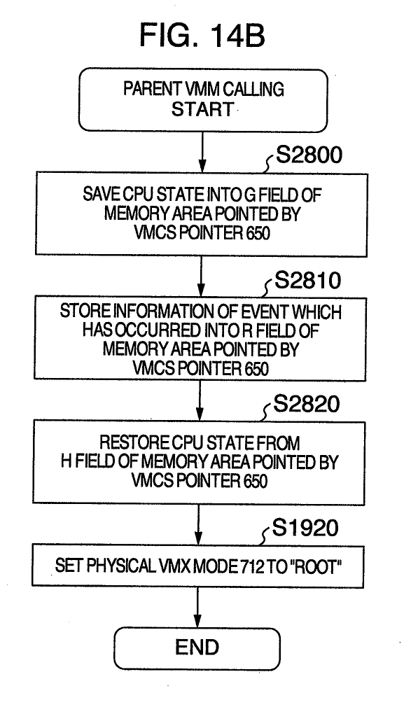

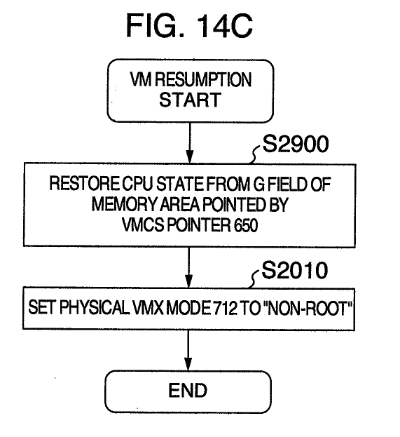

Initialization processing of the virtual machine conducted at S1700 shown in FIG. 7 will now be described with reference to FIG. 14A.

At S1800, the parent VMM 20 secures a memory area where the field partition table 400 is to be disposed. In the case of the C/H field, the parent VMM 20 sets whether the parent VMM calling is required every field to “required.” In the case of the G/R field, the parent VMM 20 sets whether the parent VMM calling is required every field to “not required.”

At S1810, the parent VMM 20 delivers an address of the memory where the field partition table 400 is disposed to the CPU 70, and initializes the field decision part 720.

At S1840, the parent VMM 20 secures a memory area where the parent VMCS for child VMM 100 is to be disposed, and sets a value of the initial state of the x86 CPU into the G field 102. The parent VMM 20 sets values required for operation of the parent VMM 20 into the H field 104 and the C field 106.

At S1850, the parent VMM 20 secures a memory area where the parent VMCS for OS 110 is to be disposed, and sets a value required for operation of the parent VMM 20 into the H field 114.

At S2700, the parent VMM 20 stores an address of the parent VMCS for child VMM 100 into the VMCS pointer 650, and activates the parent VMCS for child VMM 100.

At S2710, the parent VMM 20 stores the address of the parent VMCS for OS 110 into the standby pointer 660.

At S1880, the parent VMM 20 sets “root” into the logical VMX mode 714 to cause the operation subject to be recognized as the child VMM 40 when the physical VMX mode 712 has become “non-root.”

### <3.3 Parent VMM Calling Processing>

The parent VMM calling processing conducted at S1725 and S1770 shown in FIG. 7 will now be described with reference to FIG. 14B.

At S2800, the CPU 70 saves the CPU state into the G field of the VMCS pointed by the VMCS pointer 650. While the child VMM 40 is operating, the VMCS pointer 650 points the parent VMCS for child VMM 100 and consequently the CPU state is saved into the G field 102 (a fifth data structure) of the parent VMCS for child VMM. On the other hand, while the OS 50/AP 60 is operating, the VMCS pointer 650 points the parent VMCS for OS 110 and consequently the CPU state is saved into the G field 112 (a third data structure) of the parent VMCS for OS.

At S2810, the CPU 70 stores information of an event which has become the cause of calling the parent VMM 20 into the R field of the VMCS pointed by the VMCS pointer 650.

At S2820, the CPU 70 restores the CPU state from the H field of the VMCS pointed by the VMCS pointer 650.

At S1920, the CPU 70 sets the physical VMX mode 712 to “root” and changes over the operation subject to the parent VMM 20.

### <3.4 Guest Resumption Processing>

The guest resumption processing conducted at S1705, S1735 and S1780 shown in FIG. 7 will now be described with reference to FIG. 14C.

At S2900, the parent VMM 20 restores the CPU state from the G field of the VMCS pointed by the VMCS pointer 650. When resuming the child VMM 40, the VMCS pointer 650 points the parent VMCS for child VMM 100 and consequently the CPU state is restored from the G field 102 (the fifth data structure which becomes the saving/restoration destination of the CPU state when interrupting and resuming the VMM) of the parent VMCS for child VMM. On the other hand, when resuming the OS 50/AP 60, the VMCS pointer 650 points the parent VMCS for OS 110, and consequently the CPU state is stored from the G field 112 of the parent VMCS for OS.

At S2010, the parent VMM 20 sets the physical VMX mode 712 to “non-root” and changes over the operation subject to one of the child VMM40/OS 50/AP 60 according to the combination of the logical VMX mode 714 and the CPL 719.

### <3.5 OS-Oriented Processing>

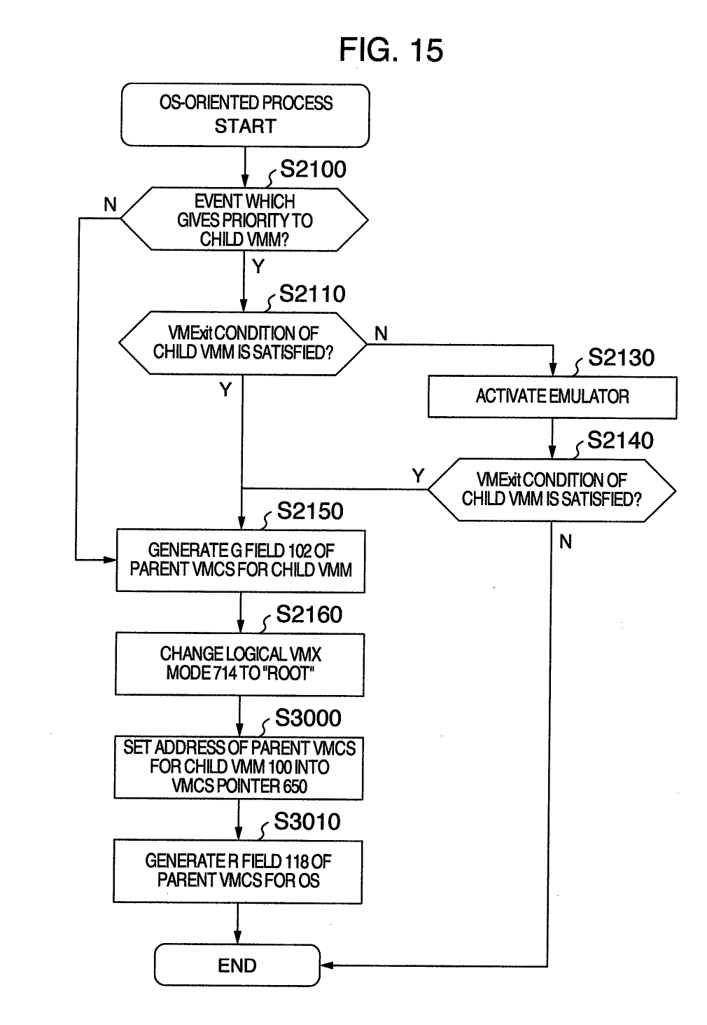

OS-oriented processing conducted at S1775 shown in FIG. 7 will now be described with reference to FIG. 15.

At S2100, the parent VMM 20 refers to the R field of the VMCS pointed by the VMCS pointer 650, and grasps the event which has occurred. Then, the calling priority decision part 320 in the parent VMM 20 makes a decision whether to give priority to processing in the child VMM 40 or give priority to processing in the parent VMM 20 according to the kind of the event which has occurred. If the processing in the child VMM 40 is given priority, the processing proceeds to S2110. If the processing in the parent VMM 20 is given priority, the processing proceeds to S2150.

At S2110, the child VMM calling decision part 330 in the parent VMM 20 collates the event which has occurred with the C field 506 (a first data structure prescribing an event which becomes a condition of calling the child VMM during operation of the OS) of the child VMCS pointed by the child VMCS pointer 140, and makes a decision whether the condition of calling the child VMM 40 is satisfied. If the condition of calling the child VMM 40 is satisfied, the processing proceeds to S2150. Otherwise, the processing proceeds to S2130.

At S2130, the parent VMM 20 conducts emulation on the behavior of the machine according to the event, and updates the state of the virtual machine 30.

At S2140, the parent VMM 20 makes a decision whether the event prescribed in the C field 506 of the child VMCS has occurred as a result of the processing conducted at S2130. If the event has occurred, the processing proceeds to S2150. Otherwise, the present procedure is finished.

At S2150, the parent VMM 20 refers to the H field 504 of the child VMCS pointed by the child VMCS pointer 140, and copies it into the G field 102 of the parent VMCS for child VMM. As a result of the present processing, a setting value in the H field 504 of the child VMCS which retains the initial state of the child VMM 40 is reflected to the CPU.

At S2160, the parent VMM 20 changes the logical VMX mode 714 to “root” to cause the operation subject to be recognized as the child VMM 40 when resuming the guest next time.

At S3000, the VMCS pointer 650 is caused to retain the address of the parent VMCS for child VMM 100 to prepare for resumption of the child VMM 40.

At S3010, the parent VMM 20 generates the R field 118 of the parent VMCS for OS to be referred to by the child VMM 40 in preparation for readout of the R field by the child VMM 40. If the event which has called the parent VMM 20 coincides with the event which becomes a cause of calling the child VMM 40, there is no processing to be conducted in the present procedure because the CPU stores information of the event in the R field 118 of the parent VMCS for OS when the parent VMM 20 is called. On the other hand, if the event which has called the parent VMM 20 does not coincide with the event which becomes the cause of calling the child VMM 40, the parent VMM 20 overwrites information of the event.

### <3.6 Child VMM-Oriented Processing>

The child VMM-oriented processing conducted at S1745 shown in FIG. 7 will now be described with reference to FIG. 10. In the present processing, S2210, S2220, S2230, S2240, S2250 and S2255 differ from those in the first embodiment.

At S2210, the CPU 70 conducts processing for changing over the VMCS pointer 650 to resume the OS 50/AP 60.

At S2220, the parent VMM 20 or the CPU 70 reads out the pertinent field of the child VMCS 500 pointed by the child VMCS pointer 140 or the parent VMCS for OS 110 pointed by the standby pointer 660, and stores it into a register or the memory according to a parameter of the VMREAD instruction.

At S2230, the parent VMM 20 or the CPU 70 updates the pertinent field of the child VMCS 500 pointed by the child VMCS pointer 140 or the parent VMCS for OS 110 pointed by the standby pointer 660. Furthermore, the parent VMM 20 updates the C field 106 of the parent VMCS for OS as occasion demands.

At S2240, the parent VMM 20 or the CPU 70 reflects all data reserved in writing to the memory as regards the child VMCS 500 specified by an instruction parameter, if any, to the memory, and updates the child VMCS to the latest state.

At S2250, the parent VMM 20 reads out the child VMCS pointer 140, and stores it into a register or the memory according to a parameter of the VMPTRST instruction.

At S2255, the parent VMM 20 conducts update of the child VMCS 500, update of the parent VMCS for OS 110, and update of the child VMCS pointer 140 in correspondence with inactivation/activation of the child VMCS 500 caused by execution of VMPTRLD.

### <3.7. VMENTRY Processing>

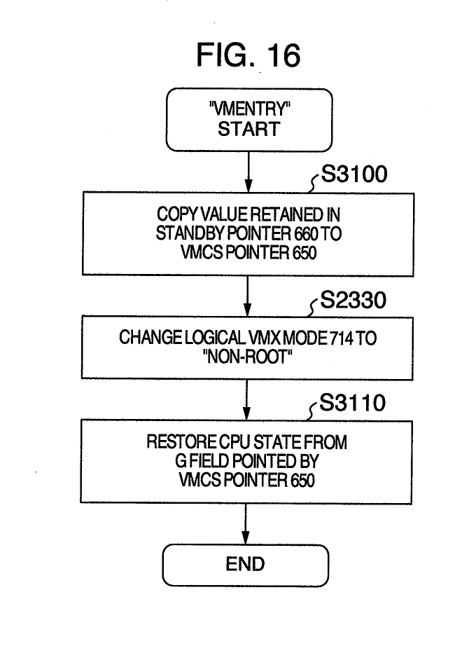

VMENTRY processing conducted at S2210 shown in FIG. 10 will now be described with reference to FIG. 16.

At S3100, the CPU 70 reads out the value of the standby pointer 660, copies the value into the VMCS pointer 650, and prepares for resumption of the OS 50/AP 60.

At S2330, the CPU 70 changes the logical VMX mode 714 to non-root” and changes over the operation subject to the OS 50 or the AP 60 according to the CPL 719.

At S3110, the CPU 70 refers to the VMCS pointer 650, and restores the CPU state from the G field 112 (the third data structure which becomes a saving/destination of the CPU state when interrupting and resuming the OS) of the parent VMCS for OS.

### <3.8. VMREAD Processing>

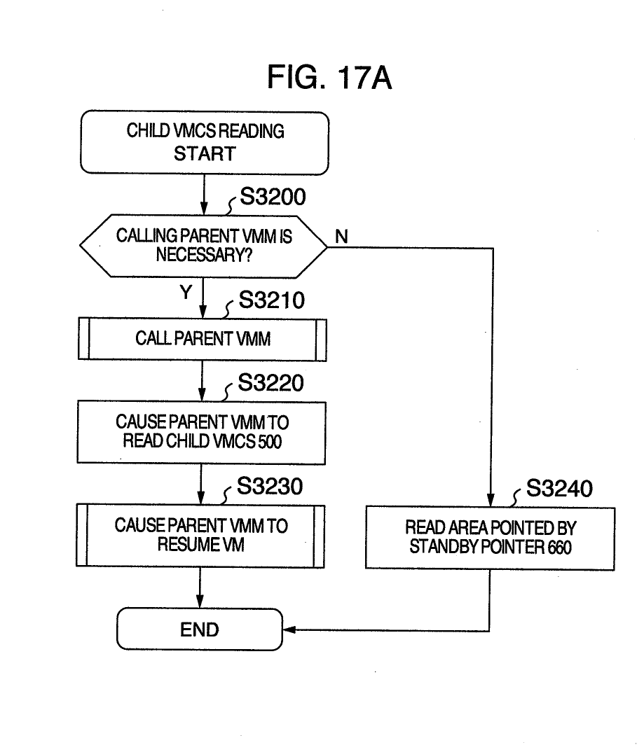

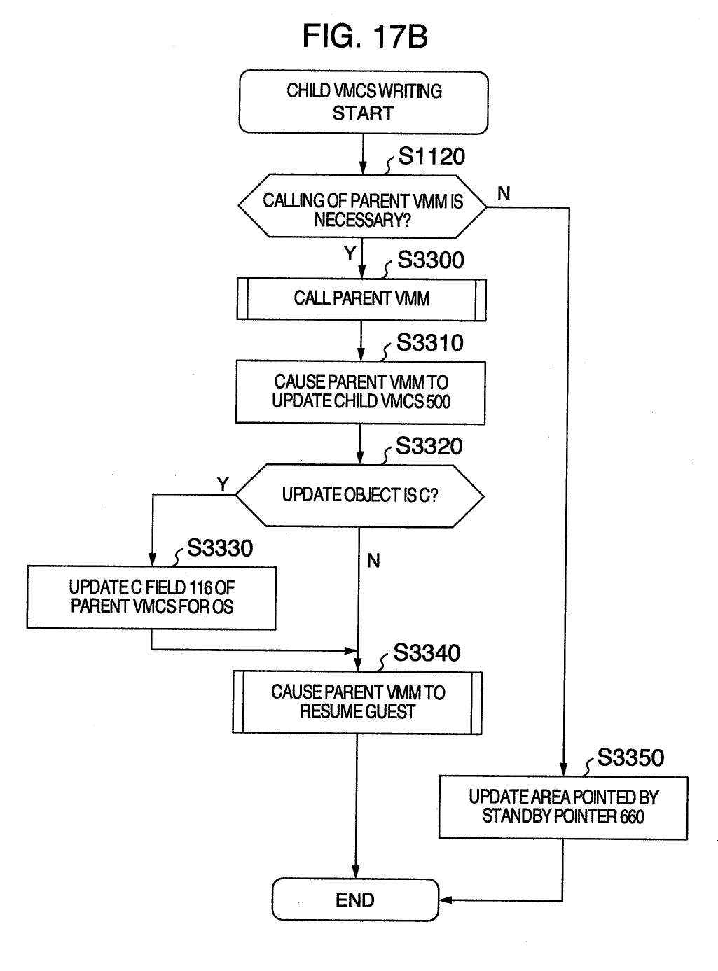

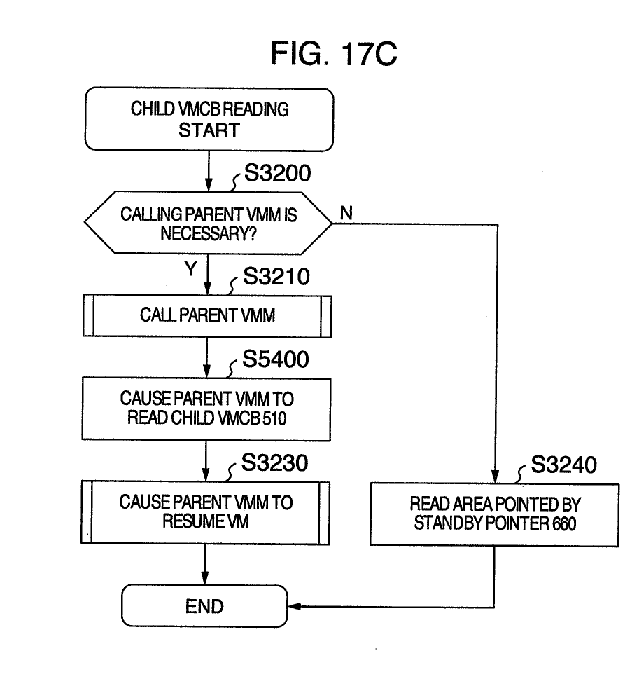

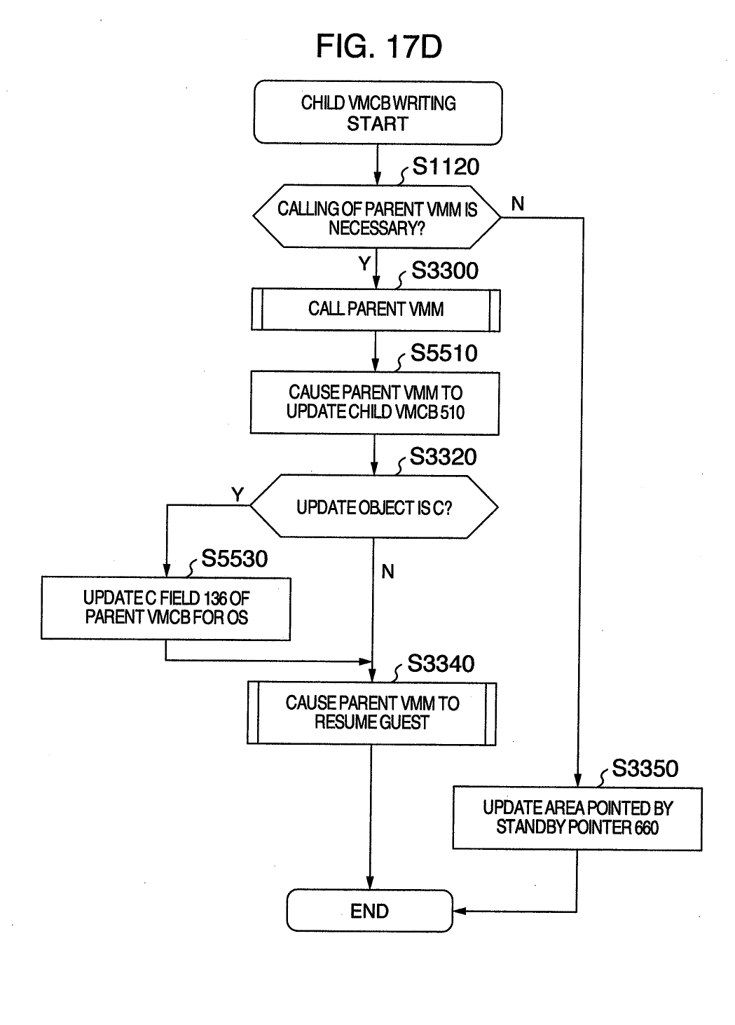

The VMREAD processing conducted at S2220 shown in FIG. 10 will now be described with reference to FIG. 17A.

At S3200, the field decision part 720 refers to the field partition table 400 by using an offset of the updated field, and finds the field partition 410 corresponding to a head offset 403 of an area including the offset and a size 406 of the area. If the field partition 410 indicates “to be processed by parent VMM,” then calling of the parent VMM 120 is judged to be necessary and the processing proceeds to S3210. If the field partition 410 indicates “to be processed only by CPU,” then the calling of the parent VMM 20 is judged to be unnecessary, and the processing proceeds to S3240.

At S3210, the CPU 70 calls the parent VMM 20.

At S3220, the parent VMM 20 refers to the child VMCS pointer 140, reads out the pertinent field of the active child VMCS 500, and updates the value in the memory or register in accordance with the parameter of VMREAD.

At S3230, the parent VMM 20 releases the CPU 70 and causes the guest execution to be resumed.

At S3240, the CPU 70 refers to the standby pointer 660, reads out the pertinent field of the parent VMCS for OS 110, and updates the value in the memory or register in accordance with the parameter of VMREAD.

### <3.9. VMWRITE Processing>

The VMWRITE processing conducted at S2220 shown in FIG. 10 will now be described with reference to FIG. 17B.

At S1120, the field decision part 720 refers to the field partition table 400 by using an offset of the updated field, and finds the field partition 410 corresponding to a head offset 403 of an area including the offset and a size 406 of the area. If the field partition 410 indicates “to be processed by parent VMM,” calling of the parent VMM 20 is judged to be necessary and the processing proceeds to S3300. If the field partition 410 indicates “to be processed only by CPU,” calling of the parent VMM 20 is judged to be unnecessary and the processing proceeds to S3350.

At S3300, the CPU 70 calls the parent VMM 20.

At S3310, the parent VMM 20 recognizes an update object by referring to the R field 108 of the parent VMCS for child VMM, and updates the pertinent field of the active child VMCS 500 by referring to the child VMCS pointer 140.

At S3320, the parent VMM 20 makes a decision whether the update object is the C field. If the update object is the C field, the processing proceeds to S3330. If the update object is the H field, the processing proceeds to S3340.

At S3330, the parent VMM 20 refers to the C field 506 of the child VMCS on the basis of a value retained in the child VMCS pointer 140, and updates the C field 116 of the parent VMCS for OS so as to include all events included in the C field 506 of the child VMCS.

At S3340, the parent VMM 20 releases the CPU 70 and causes the guest execution to be resumed.

At S3350, the CPU 70 refers to the standby pointer 660, and updates the pertinent field of the parent VMCS for OS 110.

### <3.10. VMCLEAR Processing>

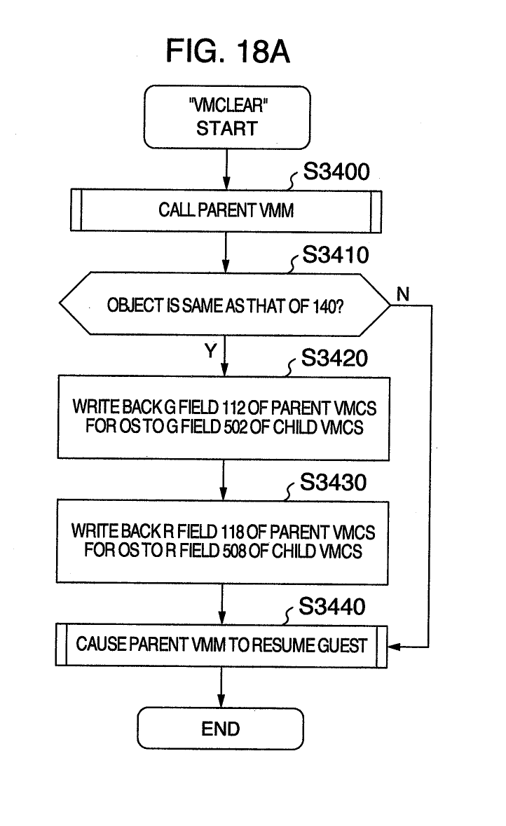

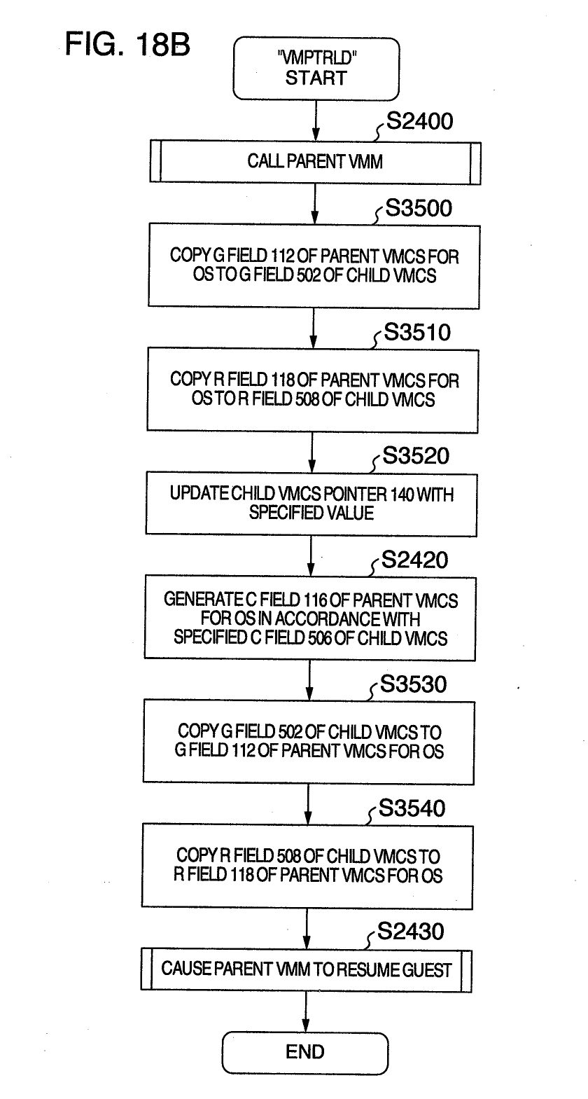

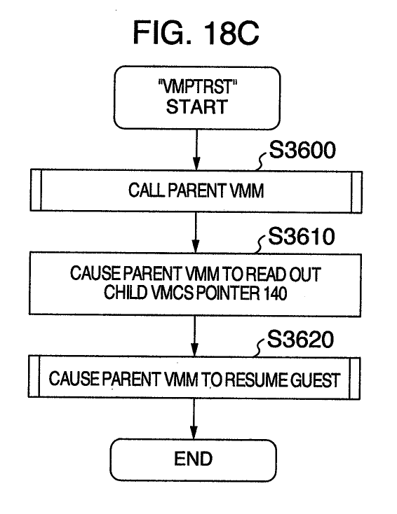

VMCLEAR processing conducted at S2240 in FIG. 10 will now be described with reference to FIG. 18A. In the present processing, the child VMCS 500 is updated to the latest state in preparation for execution of an ordinary memory operation instruction by the child VMM.

At S3400, the CPU 70 calls the parent VMM 20.

At S3410, the parent VMM 20 compares the parameter of VMCLEAR with the value retained in the child VMCS pointer 140. If the values are the same, the processing proceeds to S3420. If the values do not coincide with each other, the processing proceeds to S3440.

At S3420, the parent VMM 20 refers to the child VMCS pointer 140, and writes back the value retained in the G field 112 of the parent VMCS for OS, which is a temporary copy, into the G field 502 of the child VMCS.

At S3430, the parent VMM 20 refers to the child VMCS pointer 140, and writes back the value retained in the R field 118 of the parent VMCS for OS, which is a temporary copy, into the R field 508 of the child VMCS.

At S3440, the CPU 70 refers to the standby pointer 660, and updates the pertinent field of the parent VMCS for OS 110.

### <3.11. VMPTRLD Processing>

The VMPTRLD processing conducted at S2255 shown in FIG. 10 will now be described with reference to FIG. 18B. In the present processing, the child VMCS before changeover is updated to the latest state and the parent VMCS for OS corresponding to the child VMCS after the changeover is prepared.

At S2400, the CPU 70 calls the parent VMM 20.

At S3500, the parent VMM 20 refers to the child VMCS pointer 140, and writes back the value retained in the G field 112 of the parent VMCS for OS, which is a temporary copy, into the G field 502 of the child VMCS.

At S3510, the parent VMM 20 refers to the child VMCS pointer 140, and writes back the value retained in the R field 118 of the parent VMCS for OS, which is a temporary copy, into the R field 508 of the child VMCS.

At S3520, the parent VMM 20 copies the address of the child VMCS 500 specified by the parameter of VMPTRLD into the child VMCS pointer 140.

At S2420, the C field 506 of the parent VMCS for OS is updated so as to include all of events included in the C field 506 of the child VMCS specified by the parameter of the VMPTRLD instruction and events included in the C field 106 of the parent VMCS for child VMM.

At S3530, the parent VMM 20 refers to the child VMCS pointer 140 and copies the value retained in the G field 502 of the child VMCS into the G field 112 of the parent VMCS for OS, which is a temporary copy.

At S3540, the parent VMM 20 refers to the child VMCS pointer 140 and copies the value retained in the R field 508 of the child VMCS into the R field 118 of the parent VMCS for OS, which is a temporary copy.

At S2430, the parent VMM 20 releases the CPU 70 and causes the guest operation to be resumed.

### <3.12. VMPTRST Processing>

The VMPTRST processing conducted at S2250 shown in FIG. 10 will now be described with reference to FIG. 18C.

At S3600, the CPU 70 calls the parent VMM 20.

At S3610, the parent VMM 20 takes out the value retained in the child VMCS pointer 140, and copies the value into a register or the memory in accordance with the parameter of the VMPTRST instruction.

At S3620, the parent VMM 20 releases the CPU 70 and causes the guest operation to be resumed.

### <4. Summary>

According to the embodiment described heretofore, update contents of the G field update of the child VMCS which is high in frequency are reflected directly to the parent VMCS for OS, and the pointer in the CPU is replaced for subsequent VMENTRY. Since calling of the parent VMM which causes performance degradation can be avoided owing to the processing described heretofore, fast update and VMENTRY can be implemented. On the other hand, if the C field is updated, then the parent VMM prepares the corresponding parent VMCS for OS instantly. Furthermore, since the function of the CPU is expanded only for the G field, the increase of the semiconductor quantity and power dissipation of the CPU can also be suppressed.

### Third Embodiment

Hereafter, an embodiment in which the child VMM is caused to utilize a SVM function and the G field of the child VMCB is also used for the G field of the parent VMCB for OS, as a common memory area will be described. In the present embodiment, update of the child VMCB conducted by the child VMM is reflected to the parent VMCB for OS instantly or when the OS operation is resumed next time. Hereafter, a difference from the first embodiment will be described with reference to accompanying drawings.

### <1. Hardware Configuration>

FIG. 2 shows a configuration of a physical machine which causes a two-level virtual machine system to operate in the third embodiment of the present invention. In the present embodiment, the physical machine 10 includes at least one CPU 70 corresponding to the SVM function. Remaining elements are the same as those in the first embodiment.

### <2. Software Configuration>

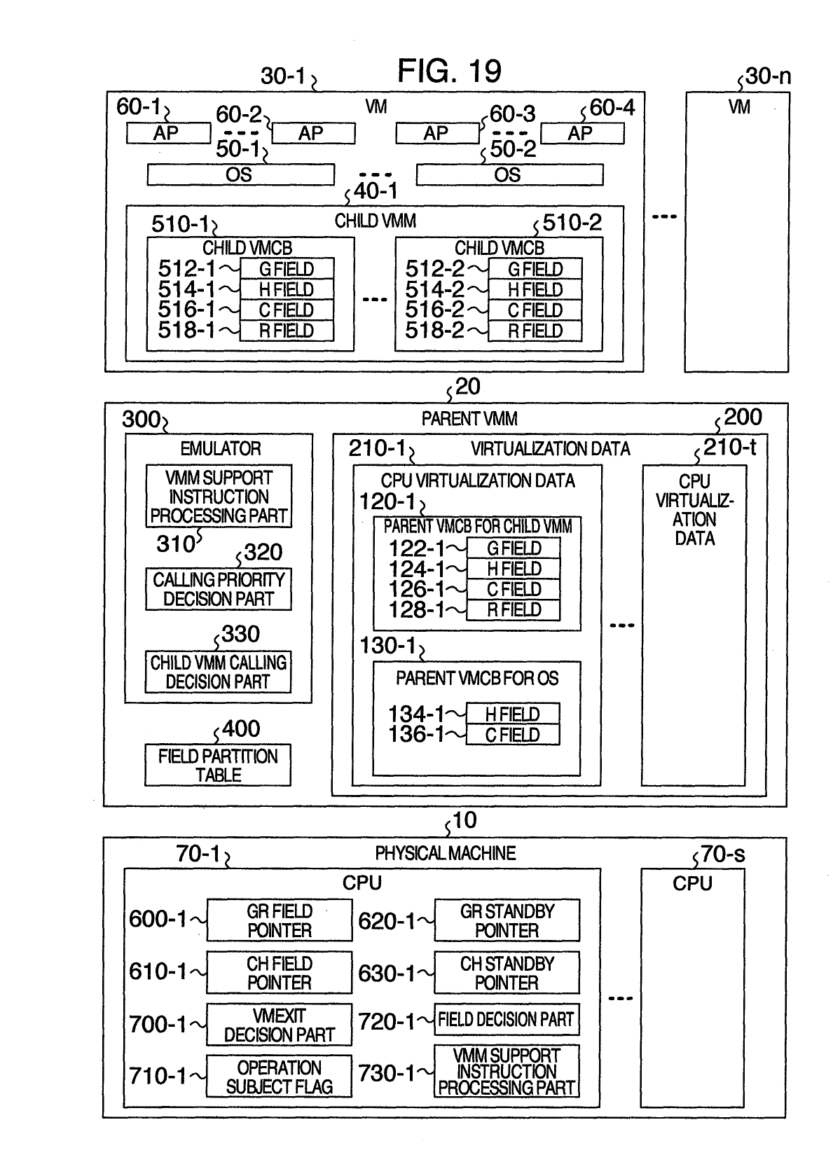

A principal part of a configuration of software which implements the virtual machine 30 on the physical machine 10 and hardware elements which become control objects will now be described in detail with reference to FIG. 19.

The physical computer 10 differs from that in the first embodiment only in the function of the CPU 70. The CPU 70 is a CPU corresponding to the SVM function. The CPU 70 operates by referring to the VMCB (Virtual Machine Control Block), which is a data structure for controlling the SVM function. According to specifications of the SVM function, only one VMCB is activated. In the present embodiment, however, the function of the CPU 70 is expanded to retain addresses of the VMCBs of four kinds which differ in use. The GR field pointer 600 retains an address of a VMCB which includes a G (Guest state) field for saving and restoring the state at the time of guest operation and an R (exit Reason) field for retaining information of an event which becomes a cause of VMM calling.

A CH field pointer 610 retains an address of a VMCB including a C (Condition) field for retaining a parent VMM calling condition and an H (Host state) field which is a reservation area for saving and restoring a state of host operation. A GR standby pointer 620 retains an address of a VMCB including a G field and an R field used when causing the OS 50 and the AP 60 to operate. A CH standby pointer 630 retains an address of a VMCB including a C field and an H field used to cause the OS 50 and the AP 60 to operate.

A VMEXIT decision part 700 monitors operation of the child VMM 40/the OS 50/the AP 60, and makes a decision whether a parent VMM calling condition prescribed in an address retained in a C field pointer 615 is satisfied. An operation subject flag 710 manages as to which of the parent VMM 20/the child VMM 40/the OS 50/the AP 60 is software operating on the CPU 70. When the child VMM updates a field of the VMCB, the field decision part 720 makes a decision whether the object is a field a note of a change of which should be given to the parent VMM. A VMM support instruction processing part 730 processes instructions, i.e., a memory operation instruction for referring to/updating the VMCB, and VMRUN for specifying an address of the VMCB and starting/resuming operation of the OS 50 and AP 60.

The parent VMM 20 differs from that in the first embodiment only in the field partition table 400 and components of the CPU virtualization data 210. The field partition table 400 is a table which prescribes whether to call the parent VMM when the child VMM updates the VMCB. The CPU virtualization data 210 includes a parent VMCB for child VMM 120 used to cause the child VMM to operate, and a parent VMCB for OS 130 used to cause the OS and the AP to operate. The parent VMCB for child VMM 120 includes all of a G field 122, an H field 124, a C field 126, and an R field 128 of the VMCB. The parent VMCB for OS 130 includes only an H field 134 and a C field 136.

In each virtual machine 30, the child VMM 40 operates. On the child VMM 40, the OS 50 and the AP 60 operate. The child VMM 40 retains a child VMCB 510 for each virtual CPU assigned to the OS 50. The child VMCB 510 includes all of a G field 512, an H field 514, a C field 516 and an R field 518 of the VMCB.

The GR field pointer 600 retains an address of the parent VMCB for child VMM 120 while the child VMM 40 is operating. On the other hand, while the OS 50 and the AP 60 are operating, the GR field pointer 600 retains an address of the child VMCB 510. In other words, operation states of the OS 50 and the AP 60 are saved and restored by using the child VMCB 510 directly.

The CH field pointer 610 retains an address of the parent VMCB for child VMM 120 while the child VMM 40 is operating. On the other hand, while the OS 50 and the AP 60 are operating, the CH field pointer 610 retains an address of the parent VMCB for OS 130. In other words, as for the parent VMM calling condition (parent VMEXIT condition) applied while the OS 50 and the AP 60 are operating, the C field of not the child VMCB 510 but the parent VMCB for OS 130 is applied.

The GR standby pointer 620 always retains an address of the child VMCB 510. When the operation subject changes from the child VMM 40 to the OS 50/AP 60, the GR standby pointer 620 supplies the address of the child VMCB 510 to the GR field pointer 600.

The CH standby pointer 630 always retains an address of the parent VMCB for OS 130. When the operation subject changes from the child VMM 40 to the OS 50/AP 60, the CH standby pointer 630 supplies the address of the parent VMCB for OS 130 to the CH field pointer 610.

The C field 126 (a fourth data structure) of the parent VMCB for child VMM retains individual setting of the parent VMM. The C field 136 (a second data structure) of the parent VMCB for OS 130 includes all of events which become the child VMM calling condition prescribed in the C field 516 (a first data structure) of the child VMCB.

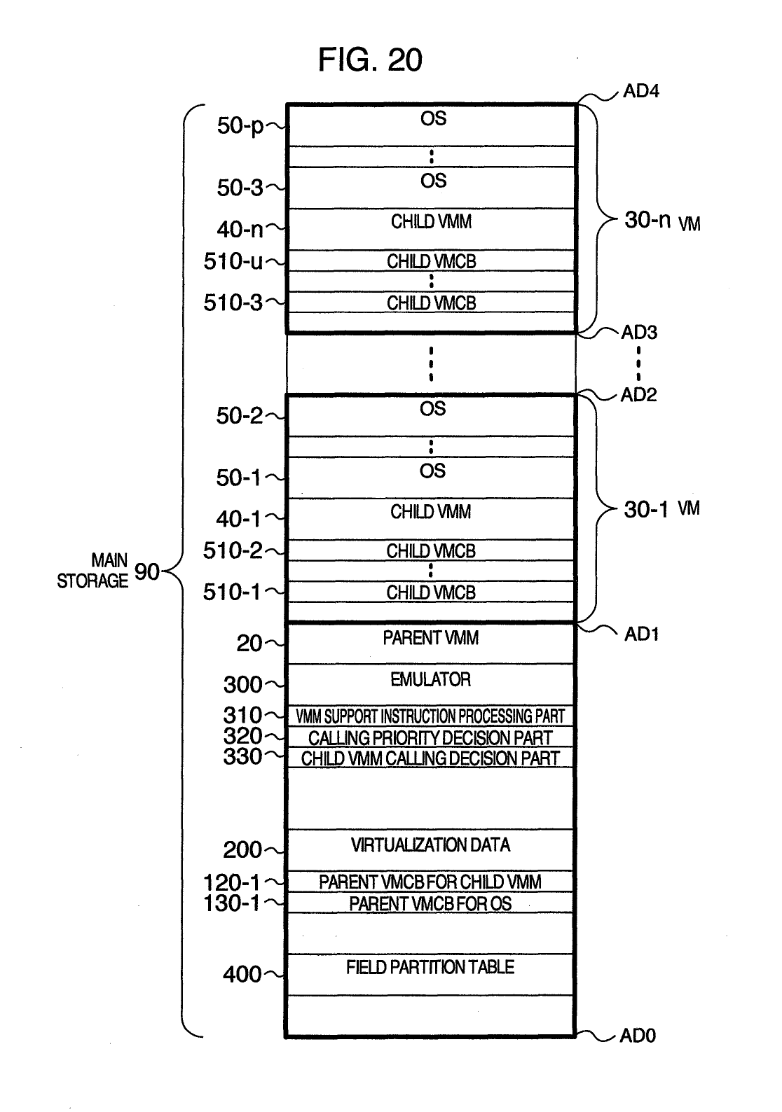

FIG. 20 shows an example of the main storage 90 managed by the parent VMM 20. It differs from that in the first embodiment only in the VMCB which controls the SVM function. The virtualization data 200 includes the parent VMCB for child VMM 120 and the parent VMCB for OS 130. The child VMM 40 and the OS 50 are included in the area of each virtual machine 30. The child VMM 40 uses a part of the memory area as the child VMCB 510.

FIG. 29B shows a format of the child VMCB 510. The VMCB has a size of 4 KB. A large number of fields each having a size in the range of 2 to 8 bytes are mixedly present in the 4 KB. The parent VMCB for child VMM 120 also has the same format. As for the parent VMCB for OS 130, the format is the same although the G field and the R field are not used.

FIG. 5 shows an example of a configuration diagram of the field partition table 400. Since the field partition table 400 has the same configuration as that in the first embodiment, its description will be omitted. In the third embodiment, the field partition table is generated so as to cause the parent VMM to process only the C field of the VMCB and cause only the CPU to process the G field/H field/R field.

FIG. 6B shows a configuration of the operation subject flag 710. The operation subject flag includes a physical SVM mode 718, a logical SVM mode 718, and a CPL 719. If the operation subject is the VMM 20, the physical SVM mode 716 retains “host.” If the operation subject is the child VMM 40/OS 50/AP 60, the physical SVM mode 716 retains “guest.” The logical SVM mode 718 is used only in the case where the physical SVM mode 716 is “guest.” If the operation subject is the child VMM 40, the logical SVM mode 718 retains “host.” If the operation subject is the OS 50/AP 60, the logical SVM mode 718 retains “guest.” The CPL 719 is used only in the case where both the physical SVM mode 716 and the logical SVM mode 718 are “guest.” If the operation subject is the OS 50, the CPL 719 retains 0. If the operation subject is the AP 60, the CPL 719 retains 3.

### <3. Virtualization Processing Conducted by Parent VMM and CPU>

Hereafter, an example of virtualization processing conducted by the parent VMM 20 and the CPU 70 according to operation of the child VMM 40/OS 50/AP 60 will be described with reference to flow charts.

### <3.1 Outline of Virtualization Processing Conducted by Parent VMM and CPU>

FIG. 7 is a flow chart showing general processing conducted when executing the child VMM 40/OS 50/AP 60 on the parent VMM 20. The present flow chart differs from that in the first embodiment only in a procedure relating to VMCB described below.

At S1700, the parent VMM 20 generates the parent VMCB for child VMM 120, and makes preparations for causing the child VMM 40 to operate on the virtual machine 30.

At S1715, the CPU 70 makes a decision whether the child VMM 40 has executed a VMM support instruction such as VMRUN. If the child VMM 40 has executed a VMM support instruction, the processing proceeds to S1745. Otherwise, the processing proceeds to S1720.

At S1720, the CPU 70 refers to the CH field pointer 610, and makes a decision whether an event prescribed in the C field 126 (the fourth data structure prescribing an event which becomes a condition of calling the parent VMM during operation of the child VMM) of the parent VMCB for child VMM has occurred. If the event has occurred, the processing proceeds to S1725. Otherwise, the processing proceeds to S1710.

At S1755, a decision is made whether an event prescribed in the C field 126 of the parent VMCB for child VMM has occurred as a result of virtualization processing conducted at S1745. If the event has occurred, the processing proceeds to S1725. Otherwise, the processing proceeds to S1740.

At S1765, the CPU 70 refers to the CH field pointer 610, and makes a decision whether an event prescribed in the C field 136 (the second data structure prescribing an event which becomes a condition of calling the child VMM during operation of the OS) of the parent VMCB for OS has occurred. If the event has occurred, the processing proceeds to S1770. Otherwise, the processing proceeds to S1760.

### <3.2 Initialization Processing>

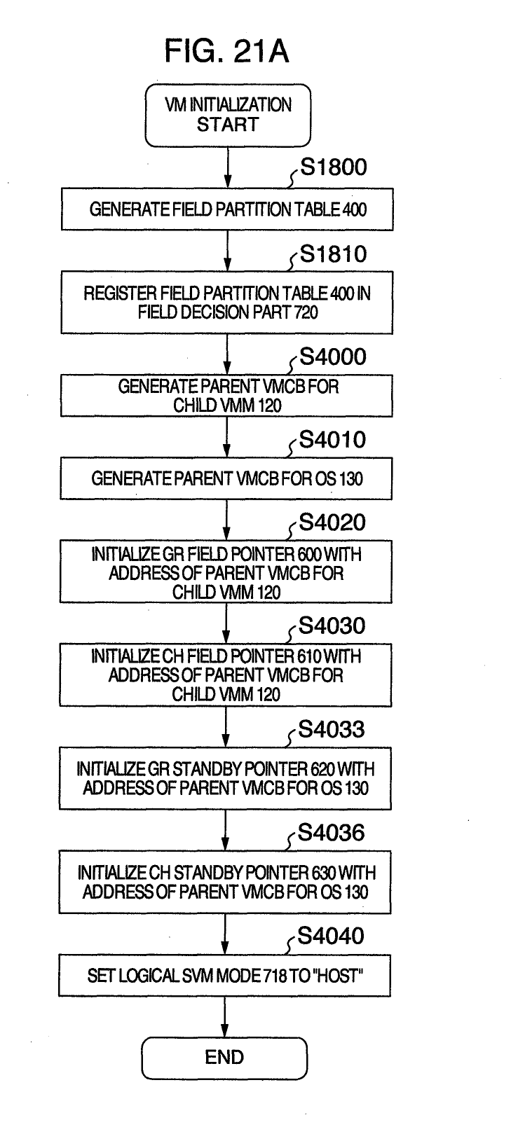

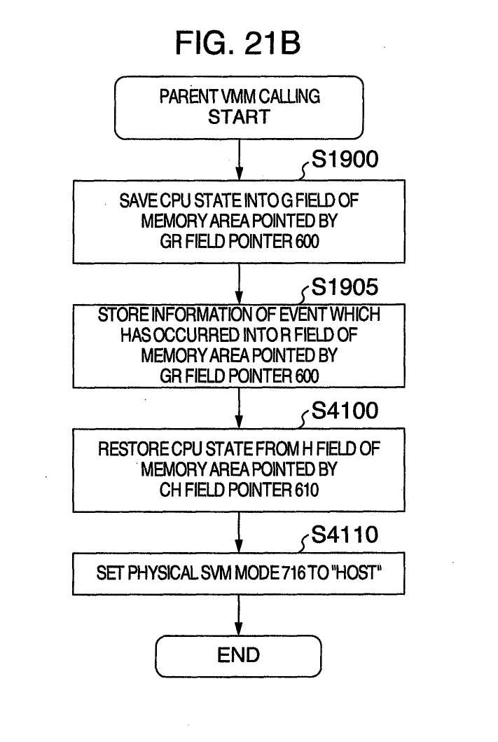

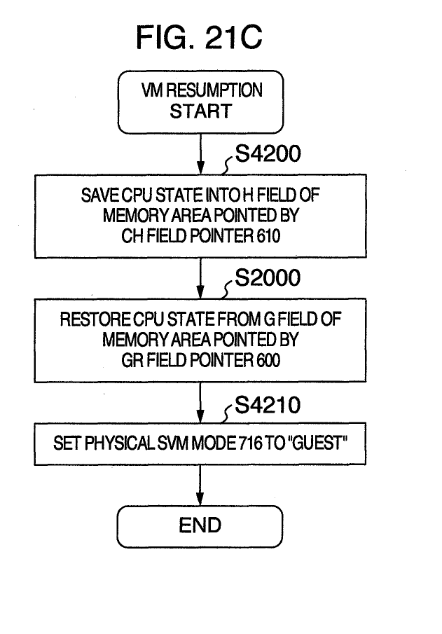

The initialization processing of the virtual machine conducted at S1700 in FIG. 7 will now be described with reference to FIG. 21A.

At S1800, the parent VMM 20 secures a memory area where the field partition table 400 is to be disposed. In the case of the C field, the parent VMM 20 sets whether the parent VMM calling is required every field to “required.” In the case of the G/R/H field, the parent VMM 20 sets whether the parent VMM calling is required every field to “not required.”

At S1810, the parent VMM 20 delivers an address of the memory where the field partition table 400 is disposed to the CPU 70, and initializes the field decision part 720.

At S4000, the parent VMM 20 secures a memory area where the parent VMCB for child VMM 120 is to be disposed, and sets a value of the initial state of the x86 CPU into the G field 122. The parent VMM 20 sets a value required for operation of the parent VMM 20 into the C field 126.

At S4010, the parent VMM 20 secures a memory area where the parent VMCB for OS 130 is to be disposed.

At S4020, the parent VMM 20 stores an address of the parent VMCB for child VMM 120 into the GR field pointer 600, and activates the parent VMCB for child VMM 120.

At S4030, the parent VMM 20 stores the address of the parent VMCB for child VMM 120 into the CH field pointer 610, and activates the parent VMCB for child VMM 120.

At S4033, the parent VMM 20 stores an address of the parent VMCB for OS 130 into the GR standby pointer 620.

At S4036, the parent VMM 20 stores the address of the parent VMCB for OS 130 into the CH standby pointer 630.

At S4040, the parent VMM 20 sets “host” into the logical SVM mode 718 to cause the operation subject to be recognized as the child VMM 40 when the physical SVM mode 716 has become “guest.”

### <3.3 Parent VMM Calling Processing>

The parent VMM calling processing conducted at S1725 and S1770 shown in FIG. 7 will now be described with reference to FIG. 21B.

At S1900, the CPU 70 saves the CPU state into the G field of the VMCB pointed by the GR field pointer 600. While the child VMM 40 is operating, the GR field pointer 600 points the parent VMCB for child VMM 120 and consequently the CPU state is saved into the G field 122 (a fifth data structure) of the parent VMCB for child VMM. On the other hand, while the OS 50/AP 60 is operating, the GR field pointer 600 points the child VMCB 510 and consequently the CPU state is saved into the G field 512 (a third data structure) of the child VMCB.

At S1905, the CPU 70 stores information of an event which has become the cause of calling the parent VMM 20 into the R field of the VMCB pointed by the GR field pointer 600.

At S4100, the CPU 70 restores the CPU state from the H field of the VMCB pointed by the CH field pointer 610. While the child VMM 40 is operating, the CH field pointer 610 points the parent VMCB for child VMM 120 and consequently the CPU state is restored from the H field 124 of the parent VMCB for child VMM. On the other hand, while the OS 50/AP 60 is operating, the CH field pointer 610 points the parent VMCB for OS 130 and consequently the CPU state is restored from the H field 134 of the parent VMCB for OS.

At S4110, the CPU 70 sets the physical SVM mode 716 to “host” and changes over the operation subject to the parent VMM 20.

### <3.4 Guest Resumption Processing>

The guest resumption processing conducted at S1705, S1735 and S1780 shown in FIG. 7 will now be described with reference to FIG. 21C.

At S4200, the parent VMM 20 saves the CPU state into the H field of the VMCB pointed by the CH field pointer 610. When resuming the child VMM 40, the CH field pointer 610 points the parent VMCB for child VMM 120 and consequently the CPU state is saved into the H field 124 of the parent VMCB for child VMM. On the other hand, when resuming the OS 50/AP 60, the CH field pointer 610 points the parent VMCB for OS 130, and consequently the CPU state is saved into the H field 134 of the parent VMCB for OS.

At S2000, the parent VMM 20 restores the CPU state from the G field of the VMCB pointed by the GR field pointer 600. When resuming the child VMM 40, the GR field pointer 600 points the parent VMCB for child VMM 120 and consequently the CPU state is restored from the G field 122 (the fifth data structure which becomes the saving/restoration destination of the CPU state when interrupting and resuming the VMM) of the parent VMCB for child VMM. On the other hand, when resuming the OS 50/AP 60, the GR field pointer 600 points the child VMCB 510, and consequently the CPU state is restored from the G field 512 of the child VMCB.

At S4210, the parent VMM 20 sets the physical SVM mode 712 to “guest” and changes over the operation subject to one of the child VMM40/OS 50/AP 60 according to the combination of the logical SVM mode 718 and the CPL 719.

### <3.5 OS-Oriented Processing>

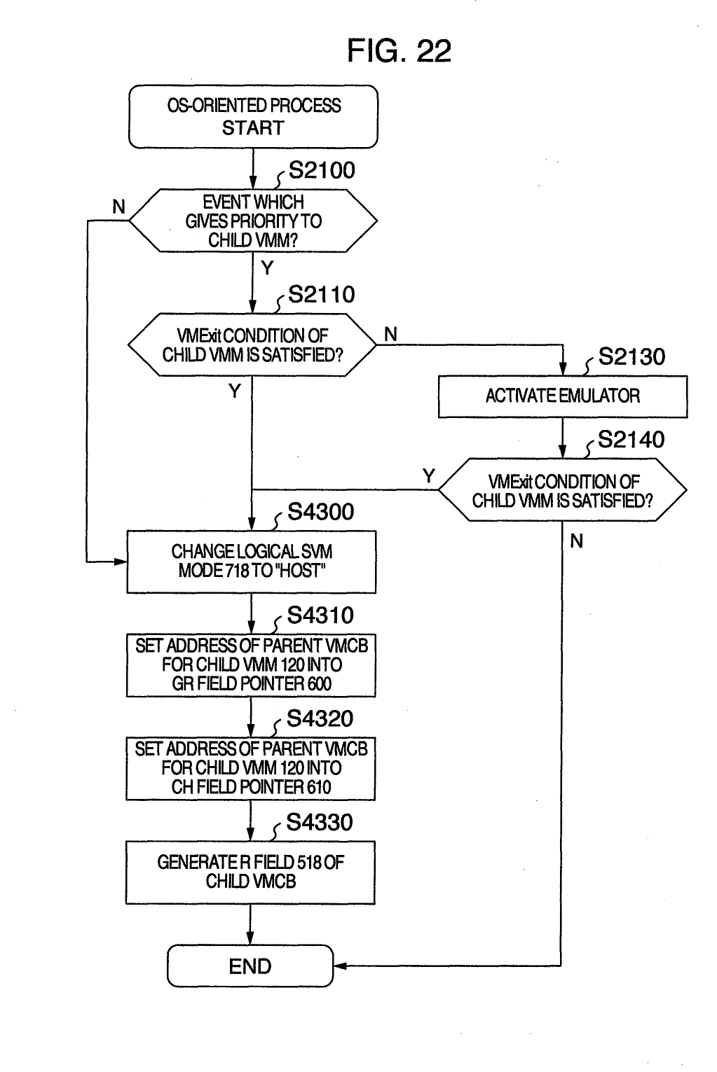

OS-oriented processing conducted at S1775 shown in FIG. 7 will now be described with reference to FIG. 22.

At S2100, the parent VMM 20 refers to the R field of the VMCB pointed by the GR field pointer 600, and grasps the event which has occurred. Then, the calling priority decision part 320 in the parent VMM 20 makes a decision whether to give priority to processing in the child VMM 40 or give priority to processing in the parent VMM 20 according to the kind of the event which has occurred. If the processing in the child VMM 40 is given priority, the processing proceeds to S2110. If the processing in the parent VMM 20 is given priority, the processing proceeds to S4300.

At S2110, the child VMM calling decision part 330 in the parent VMM 20 collates the event which has occurred with the C field 516 (the first data structure prescribing an event which becomes a condition of calling the child VMM during operation of the OS) of the child VMCB pointed by the GR field pointer 600, and makes a decision whether the condition of calling the child VMM 40 is satisfied. If the condition of calling the child VMM 40 is satisfied, the processing proceeds to S2150. Otherwise, the processing proceeds to S4300.

At S2130, the parent VMM 20 conducts emulation on the behavior of the machine according to the event, and updates the state of the virtual machine 30.

At S2140, the parent VMM 20 makes a decision whether the event prescribed in the C field 516 of the child VMCB has occurred as a result of the processing conducted at S2130. If the event has occurred, the processing proceeds to S2150. Otherwise, the present procedure is finished.

At S4300, the parent VMM 20 changes the logical SVM mode 718 to “host” to cause the operation subject to be recognized as the child VMM 40 when resuming the guest next time.

At S4310, the GR field pointer 600 is caused to retain the address of the parent VMCB for child VMM 120 to prepare for resumption of the child VMM 40.

At S4320, the CH field pointer 610 is caused to retain the address of the parent VMCB for child VMM 120 to prepare for resumption of the child VMM 40.

At S4330, the parent VMM 20 generates the R field 518 of the child VMCB. If the event which has called the parent VMM 20 coincides with the event which becomes a cause of calling the child VMM 40, there is no processing to be conducted in the present procedure because the CPU stores information of the event in the R field 518 of the child VMCB when the parent VMM 20 is called. On the other hand, if the event which has called the parent VMM 20 does not coincide with the event which becomes the cause of calling the child VMM 40, the parent VMM 20 overwrites information of the event.

### <3.6 Child VMM-Oriented Processing>

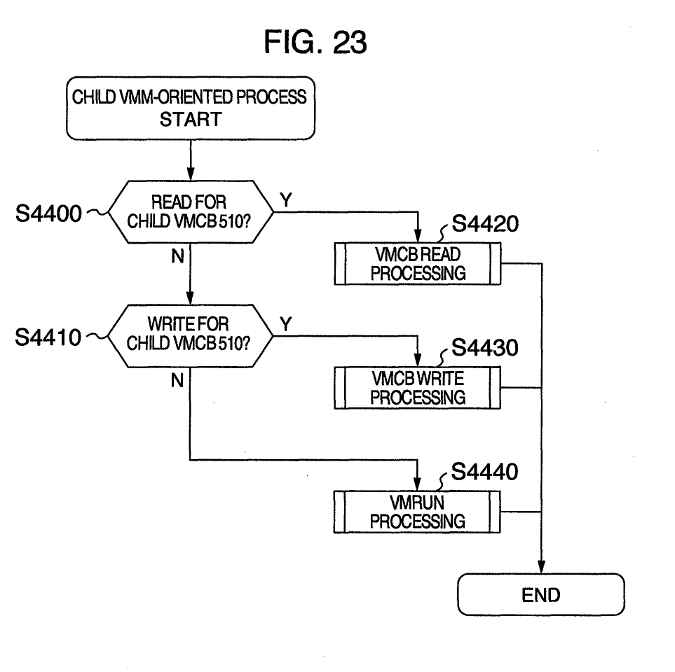

The child VMM-oriented processing conducted at S1745 shown in FIG. 7 will now be described with reference to FIG. 23.

At S4400, the CPU 70 makes a decision whether the executed instruction is memory READ to the active child VMCB 510 having an address retained in the GR standby pointer 620. If the executed instruction is the “memory READ,” the processing proceeds to S4420. Otherwise, the processing proceeds to S4410.

At S4410, the CPU 70 makes a decision whether the executed instruction is memory WRITE to the active child VMCB 510 having an address retained in the GR standby pointer 620. If the executed instruction is the memory WRITE, the processing proceeds to S4430. Otherwise, the processing proceeds to S4440.

At S4420, the CPU 70 reads out the pertinent field of the child VMCB 510 pointed by the GR standby pointer 620, and stores it into a register or the memory according to a parameter of the memory READ instruction.

At S4430, the CPU 70 updates the pertinent field of the child VMCB 510 pointed by the GR standby pointer 620. Furthermore, the CPU 70 updates the C field 126 of the parent VMCB for child VMM as occasion demands, and adds execution of a VMRUN instruction to the parent VMM 20 calling condition.

At S4440, the parent VMM 20 or the CPU 70 conducts update of the child VMCB 510, update of the parent VMCB for OS 130, and update of the GR standby pointer 620 in correspondence with inactivation/activation of the child VMCB 510 caused by execution of the VMRUN.

### <3.7. VMRUN Processing>

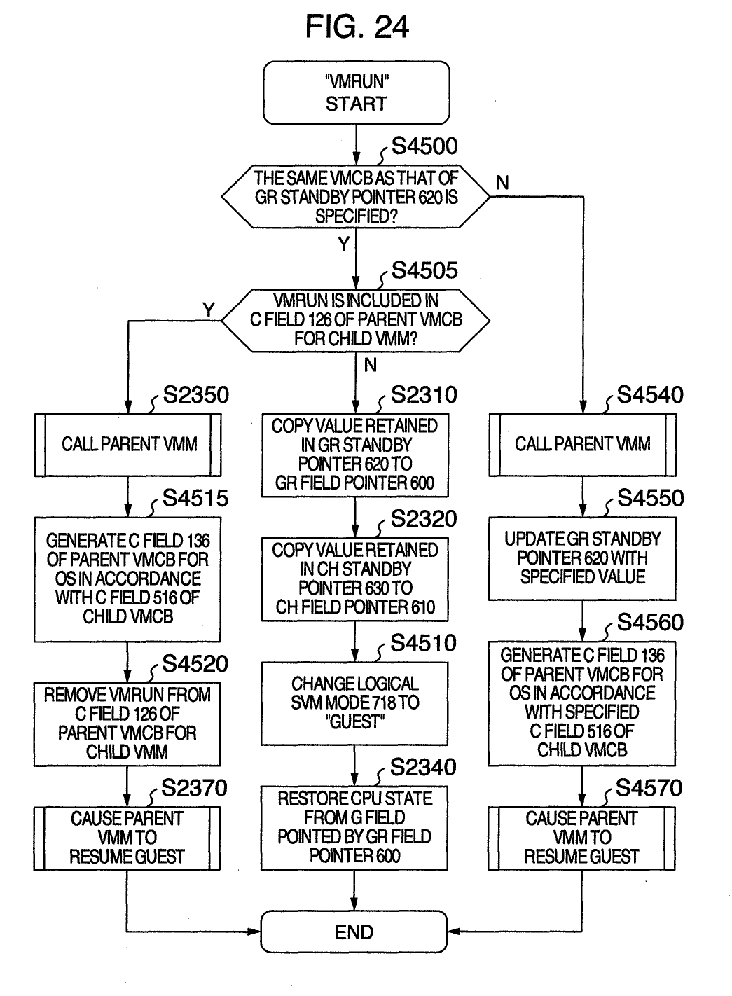

VMRUN processing conducted at S4440 shown in FIG. 23 will now be described with reference to FIG. 24.

In the present processing, changeover of a pointer for causing the OS/AP to operate is conducted. If the C field of the child VMCB is already updated, the parent VMCB for OS corresponding to the child VMCB after the update is prepared prior to the pointer changeover. When changing over the child VMCB, the child VMCB before the changeover is updated to the latest state and the parent VMCB for OS corresponding to the child VMCB after the changeover is prepared prior to the pointer changeover.

At S4500, the CPU 70 compares the address of the child VMCB retained in the GR standby pointer 620 with an address of the child VMCB specified by the parameter of the VMRUN. If they coincide with each other, the processing proceeds to S4505. Otherwise, the processing proceeds to S4550.

At S4505, the CPU 70 refers to the CH field pointer 610, and makes a decision whether execution of the VMRUN by the child VMM is included in the parent VMM calling condition in the C field 126 of the parent VMCB for child VMM. If included, the C field 516 of the child VMCB is already updated and consequently the processing proceeds to S2350. Otherwise, the processing proceeds to S2310.

At S2310, the CPU 70 reads out the value of the GR standby pointer 620, copies the value into the GR field pointer 600, and prepares for resumption of the OS 50/AP 60.

At S2320, the CPU 70 reads out the value of the CH standby pointer 630, copies the value into the CH field pointer 610, and prepares for resumption of the OS 50/AP 60.

At S4510, the CPU 70 changes the logical SVM mode 718 to “guest” and changes over the operation subject to the OS 50 or the AP 60 according to the CPL 719.

At S2340, the CPU 70 refers to the GR field pointer 600, and restores the CPU state from the G field 512 (the third data structure which becomes the saving/restoration destination of the CPU state when interrupting and resuming the OS) of the child VMCB.

At S2350, the CPU 70 calls the parent VMM 20.

At S4515, the parent VMM 20 refers to the C field 516 of the child VMCB on the basis of a value retained in the GR standby pointer 620, and updates the C field 136 of the parent VMCB for OS so as to include all of events included in the C field 516 of the child VMCB and events included in the C field 126 of the parent VMCB for child VMM.

At S4520, the parent VMM 20 removes execution of VRUN by child VMM from the parent VMM calling condition in the C field 126 of the parent VMCB for child VMM.

At S2370, the parent VMM 20 releases the CPU 70 and causes the child VMM 40 to re-execute VMRUN.

At S4540, the CPU 70 calls the parent VMM 20.

At S4550, the parent VMM 20 copies a parameter of the VMRUN instruction into the GR standby pointer 620.

At S4560, the parent VMM 20 updates the C field 136 of the parent VMCB for OS so as to include all of events included in the C field 516 of the child VMCB specified by the parameter of the VMRUN instruction.

At S4570, the parent VMM 20 releases the CPU 70 and causes the child VMM 40 to re-execute the VMRUN.

### <3.8. VMCB WRITE Processing>

The VMCB WRITE processing conducted at S4430 shown in FIG. 23 will now be described with reference to FIG. 1.

At S1100, the CPU 70 acquires the address of the child VMCB 510 by referring to the GR standby pointer 620, and updates a field specified by a parameter of memory WRITE.

At S1120, the field decision part 720 refers to the field partition table 400 by using an offset of the updated field, and finds the field partition 410 corresponding to a head offset 403 of an area including the offset and a size 406 of the area. If the field partition 410 indicates “to be processed by parent VMM,” calling of the parent VMM 20 is judged to be necessary and the processing proceeds to S1140. If the field partition 410 indicates “to be processed only by CPU,” calling of the parent VMM 20 is judged to be unnecessary and the present processing is finished.

At S1140, the CPU 70 acquires an address of the parent VMCB for child VMM by referring to the CH field pointer 610, and adds execution of VMRUN by the child VMM 40 to the C field 126 of the parent VMCB for child VMM which prescribes an event calling the parent VMM 20.

### <4. Summary>

According to the embodiment described heretofore, update contents of the G field update of the child VMCB which is high in frequency are reflected directly to the child VMCB, and the pointer in the CPU is replaced for subsequent VMRUN. Since calling of the parent VMM which causes performance degradation can be avoided owing to the processing described heretofore, fast update and VMRUN can be implemented. On the other hand, if the C field is updated, then the parent VMM prepares the corresponding parent VMCB for OS with subsequent VMRUN as a momentum, and consequently the SVM function based on specifications can be given to the child VMM. Furthermore, since the function of the CPU is expanded only for the G field, the increase of the semiconductor quantity and power dissipation of the CPU can also be suppressed.

### Fourth Embodiment

Hereafter, an embodiment in which the child VMM is caused to utilize a SVM function and the G field of the parent VMCB for OS is also used for the G field of the child VMCB, as a common memory area will be described. In the present embodiment, update of the child VMCB conducted by the child VMM is reflected to the parent VMCB for OS instantly. Furthermore, the R field of the parent VMCB for OS is also used for the R field of the child VMCB, as a common memory area. Hereafter, a difference from the third embodiment will be described with reference to accompanying drawings.

### <1. Hardware Configuration>

FIG. 2 shows a configuration of a physical machine which causes a two-level virtual machine system to operate in the fourth embodiment of the present invention. Since the configuration is the same as that in the third embodiment, however, its description will be omitted.

### <2. Software Configuration>

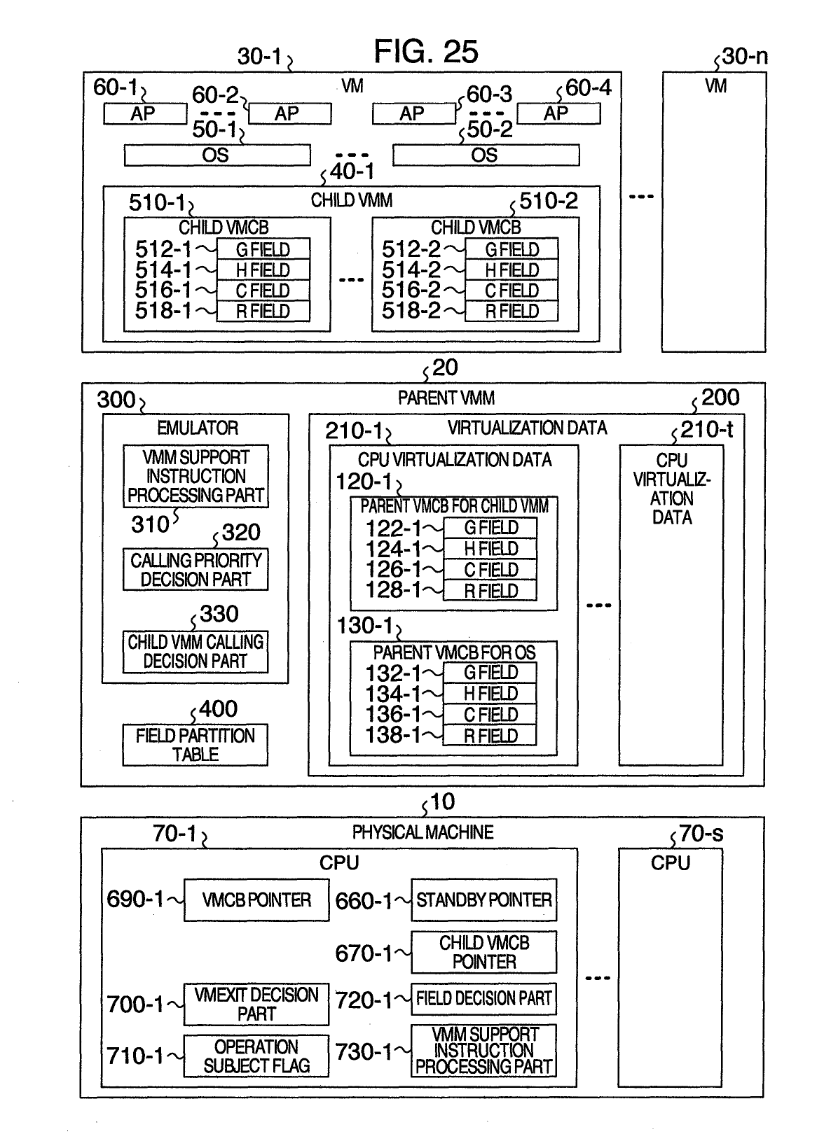

A principal part of a configuration of software which implements the virtual machine 30 on the physical machine 10 and hardware elements which become control objects will now be described in detail with reference to FIG. 25.

The physical computer 10 differs from that in the third embodiment only in the function of the CPU 70. The CPU 70 is a CPU corresponding to the SVM function. The CPU 70 operates by referring to the VMCB (Virtual Machine Control Block), which is a data structure for controlling the SVM function. According to specifications of the SVM function, only one VMCB is activated. In the present embodiment, however, the function of the CPU 70 is expanded to retain addresses of the VMCBs of three kinds which differ in use. A VMCB pointer 690 retains an address of an active VMCB. The standby pointer 660 retains an address of a VMCB which is used when causing the OS 50 and the AP 60 to operate. A child VMCB pointer 670 retains an address of the child VMCB which is managed by the child VMM 40. When the child VMM refers to/updates a field of the VMCB, the field decision part 720 makes a decision whether the object is a field a note of a change of which should be given to the parent VMM.

The parent VMM 20 differs from that in the third embodiment only in the field partition table 400 and components of the CPU virtualization data 210. The field partition table 400 is a table which prescribes whether to call the parent VMM when the child VMM refers to/updates the VMCB. The CPU virtualization data 210 includes a parent VMCB for child VMM 120 used to cause the child VMM to operate, and a parent VMCB for OS 130 used to cause the OS and the AP to operate. The parent VMCB for child VMM 120 includes all of a G field 122, an H field 124, a C field 126, and an R field 128 of the VMCB. The parent VMCB for OS 130 includes all of a G field 132, an H field 134, a C field 136, and an R field 138

Each virtual machine 30 is the same as that in the third embodiment.

The VMCB pointer 690 retains an address of the parent VMCB for child VMM 120 while the child VMM 40 is operating. On the other hand, while the OS 50 and the AP 60 are operating, the VMCB pointer 690 retains an address of the parent VMCB for OS 130. In other words, operation states of the OS 50 and the AP 60 are saved/restored by using the parent VMCB for OS 130.

The standby pointer 660 always retains an address of the parent VMCB for OS 130. When the operation subject changes from the child VMM 40 to the OS 50/AP 60, the standby pointer 660 supplies the address of the parent VMCB for OS 130 to the VMCB pointer 690.

The G field 132 of the parent VMCB for OS and the R field 138 of the parent VMCB for OS are used as temporary copies of the G field 512 of the child VMCB and the R field 518 of the child VMCB, respectively, and are synchronized with the G field 512 of the child VMCB and the R field 518 of the child VMCB as occasion demands.

FIG. 20 shows an example of the main storage 90 managed by the parent VMM 20. Since it is the same as that in the third embodiment, however, its description will be omitted.

FIG. 29B shows a format of the child VMCB 510. Since it is the same as that in the third embodiment, however, its description will be omitted.

FIG. 5 shows an example of a configuration diagram of the field partition table 400. Since the field partition table 400 has the same configuration as that in the first embodiment, its description will be omitted. In the fourth embodiment, the field partition 410 prescribes whether the parent VMM calling is required as regards not only the field update but also field reference. In the fourth embodiment, the field partition table is generated so as to cause the parent VMM to process the C field and the H field of the VMCB and cause only the CPU to process the G field and the R field.

FIG. 6B is a configuration diagram of the operation subject flag 710. Since the configuration of the operation subject flag 710 is the same as that in the third embodiment, its description will be omitted.

### <3. Virtualization Processing Conducted by Parent VMM and CPU>

Hereafter, an example of virtualization processing conducted by the parent VMM 20 and the CPU 70 according to operation of the child VMM 40/OS 50/AP 60 will be described with reference to flow charts.

### <3.1 Outline of Virtualization Processing Conducted by Parent VMM and CPU>

FIG. 7 is a flow chart showing general processing conducted when executing the child VMM 40/OS 50/AP 60 on the parent VMM 20. The present flow chart differs from that in the third embodiment only in S1720 and S1765.

At S1720, the CPU 70 refers to the VMCB pointer 690, and makes a decision whether an event prescribed in the C field 126 (a fourth data structure prescribing an event which becomes a condition of calling the parent VMM during operation of the child VMM) of the parent VMCB for child VMM has occurred. If the event has occurred, the processing proceeds to S1725. Otherwise, the processing proceeds to S1710.

At S1765, the CPU 70 refers to the VMCB pointer 690, and makes a decision whether an event prescribed in the C field 136 (a second data structure prescribing an event which becomes a condition of calling the child VMM during operation of the OS) of the parent VMCB for OS has occurred. If the event has occurred, the processing proceeds to S1770. Otherwise, the processing proceeds to S1760.

### <3.2 Initialization Processing>

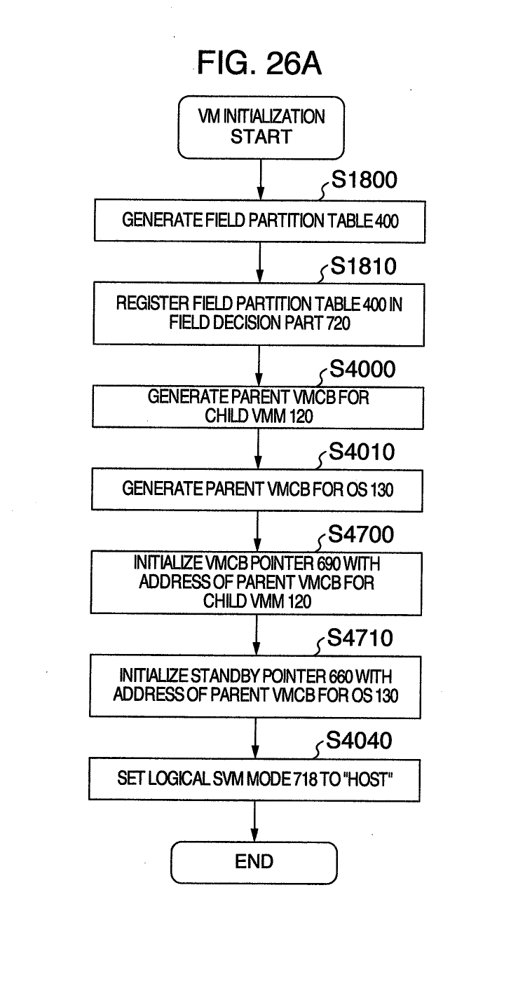

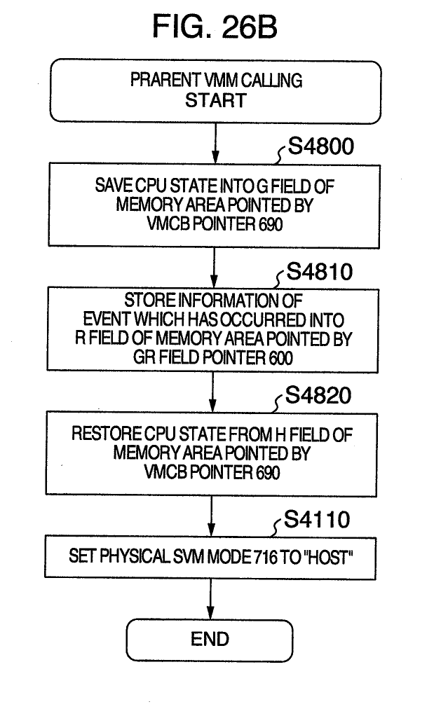

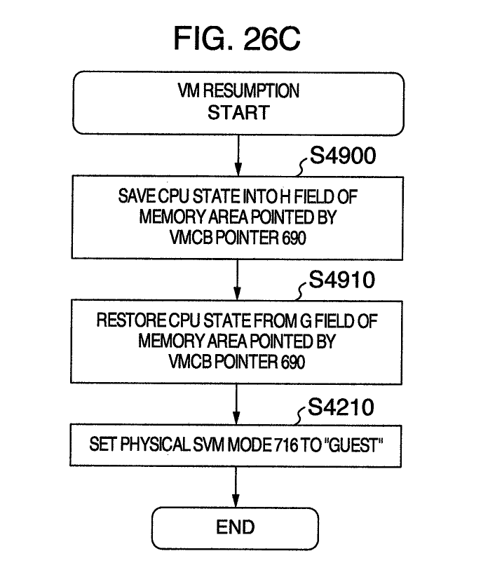

The initialization processing of the virtual machine conducted at S1700 in FIG. 7 will now be described with reference to FIG. 26A.

At S1800, the parent VMM 20 secures a memory area where the field partition table 400 is to be disposed. In the case of the C/H field, the parent VMM 20 sets whether the parent VMM calling is required every field to “required.” In the case of the G/R field, the parent VMM 20 sets whether the parent VMM calling is required every field to “not required.”

At S1810, the parent VMM 20 delivers an address of the memory where the field partition table 400 is disposed to the CPU 70, and initializes the field decision part 720.

At S4000, the parent VMM 20 secures a memory area where the parent VMCB for child VMM 120 is to be disposed, and sets a value of the initial state of the x86 CPU into the G field 122. The parent VMM 20 sets a value required for operation of the parent VMM 20 into the C field 126.

At S4010, the parent VMM 20 secures a memory area where the parent VMCB for OS 130 is to be disposed.

At S4700, the parent VMM 20 stores an address of the parent VMCB for child VMM 120 into the VMCB pointer 690, and activates the parent VMCB for child VMM 120.

At S4710, the parent VMM 20 stores an address of the parent VMCB for OS 130 into the standby pointer 660.

At S4040, the parent VMM 20 sets “host” into the logical SVM mode 718 to cause the operation subject to be recognized as the child VMM 40 when the physical SVM mode 716 has become “guest.”

### <3.3 Parent VMM Calling Processing>

The parent VMM calling processing conducted at S1725 and S1770 shown in FIG. 7 will now be described with reference to FIG. 26B.

At S4800, the CPU 70 saves the CPU state into the G field of the VMCB pointed by the VMCB pointer 690. While the child VMM 40 is operating, the VMCB pointer 690 points the parent VMCB for child VMM 120 and consequently the CPU state is saved into the G field 122 (a fifth data structure which becomes the saving/restoration destination of the CPU state when interrupting/resuming the VMM) of the parent VMCB for child VMM. On the other hand, while the OS 50/AP 60 is operating, the VMCB pointer 690 points the parent VMCB for OS 130 and consequently the CPU state is saved into the G field 132 (a third data structure) of the parent VMCB for OS.

At S1905, the CPU 70 stores information of an event which has become the cause of calling the parent VMM 20 into the R field of the VMCB pointed by the VMCB pointer 690.

At S4820, the CPU 70 restores the CPU state from the H field of the VMCB pointed by the VMCB pointer 690.

At S4110, the CPU 70 sets the physical SVM mode 716 to “host” and changes over the operation subject to the parent VMM 20.

### <3.4 Guest Resumption Processing>

The guest resumption processing conducted at S1705, S1735 and S1780 shown in FIG. 7 will now be described with reference to FIG. 26C.

At S4900, the parent VMM 20 saves the CPU state into the H field of the VMCB pointed by the VMCB pointer 690. When resuming the child VMM 40, the VMCB pointer 690 points the parent VMCB for child VMM 120 and consequently the CPU state is saved into the H field 124 of the parent VMCB for child VMM. On the other hand, when resuming the OS 50/AP 60, the VMCB pointer 690 points the parent VMCB for OS 130, and consequently the CPU state is saved into the H field 134 of the parent VMCB for OS.

At S4910, the parent VMM 20 restores the CPU state from the G field of the VMCB pointed by the VMCB pointer 690.

At S4210, the parent VMM 20 sets the physical SVM mode 716 to “guest” and changes over the operation subject to one of the child VMM40/OS 50/AP 60 according to the combination of the logical SVM mode 718 and the CPL 719.

### <3.5 OS-Oriented Processing>

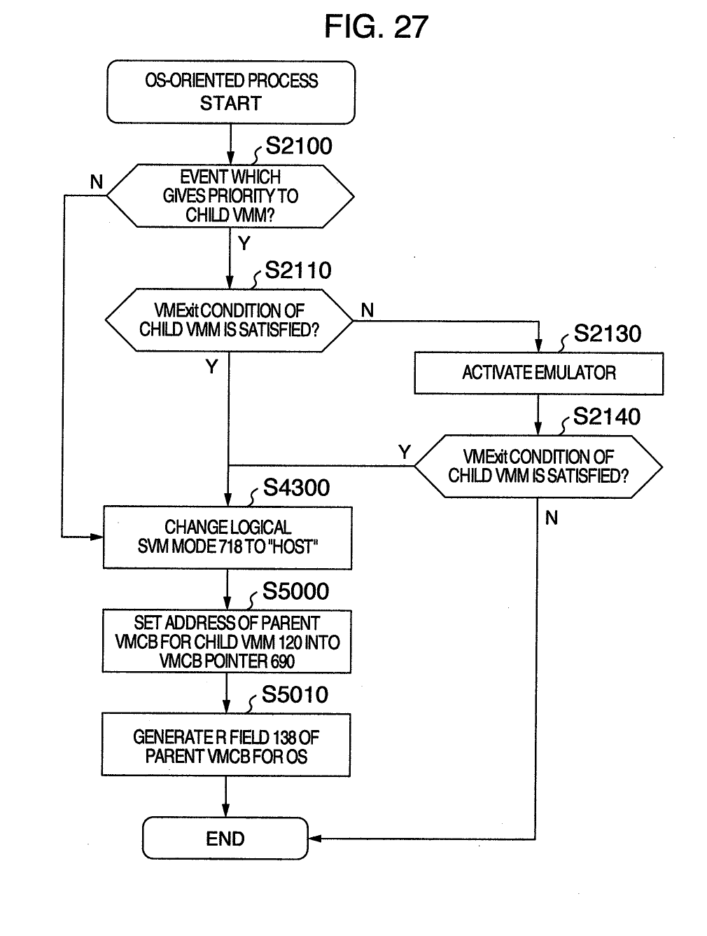

OS-oriented processing conducted at S1775 shown in FIG. 7 will now be described with reference to FIG. 27.

At S2100, the parent VMM 20 refers to the R field of the VMCB pointed by the VMCB pointer 690, and grasps the event which has occurred. Then, the calling priority decision part 320 in the parent VMM 20 makes a decision whether to give priority to processing in the child VMM 40 or give priority to processing in the parent VMM 20 according to the kind of the event which has occurred. If the processing in the child VMM 40 is given priority, the processing proceeds to S2110. If the processing in the parent VMM 20 is given priority, the processing proceeds to S4300.

At S2110, the child VMM calling decision part 330 in the parent VMM 20 collates the event which has occurred with the C field 516 (a first data structure prescribing an event which becomes a condition of calling the child VMM during operation of the OS) of the child VMCB pointed by the child VMCB pointer 670, and makes a decision whether the condition of calling the child VMM 40 is satisfied. If the condition of calling the child VMM 40 is satisfied, the processing proceeds to S4200. Otherwise, the processing proceeds to S2130.

At S2130, the parent VMM 20 conducts emulation on the behavior of the machine according to the event, and updates the state of the virtual machine 30.

At S2140, the parent VMM 20 makes a decision whether the event prescribed in the C field 516 of the child VMCB has occurred as a result of the processing conducted at S2130. If the event has occurred, the processing proceeds to S4300. Otherwise, the present procedure is finished.

At S4300, the parent VMM 20 changes the logical SVM mode 718 to “host” to cause the operation subject to be recognized as the child VMM 40 when resuming the guest next time.

At S5000, the VMCB pointer 690 is caused to retain the address of the parent VMCB for child VMM 120 to prepare for resumption of the child VMM 40.

At S5010, the parent VMM 20 generates the R field 138 of the parent VMCB for OS. If the event which has called the parent VMM 20 coincides with the event which becomes a cause of calling the child VMM 40, there is no processing to be conducted in the present procedure because the CPU stores information of the event in the R field 138 of the parent VMCB for OS when the parent VMM 20 is called. On the other hand, if the event which has called the parent VMM 20 does not coincide with the event which becomes the cause of calling the child VMM 40, the parent VMM 20 overwrites information of the event.

### <3.6 Child VMM-Oriented Processing>

The child VMM-oriented processing conducted at S1745 shown in FIG. 7 will now be described with reference to FIG. 23.

At S4400, the CPU 70 makes a decision whether the executed instruction is memory READ to the active child VMCB 510 having an address retained in the child VMCB pointer 670. If the executed instruction is the “memory READ,” the processing proceeds to S4420. Otherwise, the processing proceeds to S4410.

At S4410, the CPU 70 makes a decision whether the executed instruction is memory WRITE to the active child VMCB 510 having an address retained in the child VMCB 670. If the executed instruction is the memory WRITE, the processing proceeds to S4430. Otherwise, the processing proceeds to S4440.

At S4420, the parent VMM 20 or the CPU 70 reads out the pertinent field of the child VMCB 510 pointed by the child VMCB pointer 670 or the parent VMCB for OS 130 pointed by the standby pointer 660, and stores it into a register or the memory according to a parameter of the memory READ instruction.

At S4430, the parent VMM 20 or the CPU 70 updates the pertinent field of the child VMCB 510 pointed by the child VMCB pointer 670 or the parent VMCB for OS 130 pointed by the standby pointer 660. Furthermore, the parent VMM 20 updates the C field 126 of the parent VMCB for OS as occasion demands.

At S4440, the parent VMM 20 or the CPU 70 conducts update of the child VMCB 510, update of the parent VMCB for OS 130, and update of the child VMCB pointer 670 in correspondence with inactivation/activation of the child VMCB 510 caused by execution of the VMRUN.

### <3.7. VMRUN Processing>

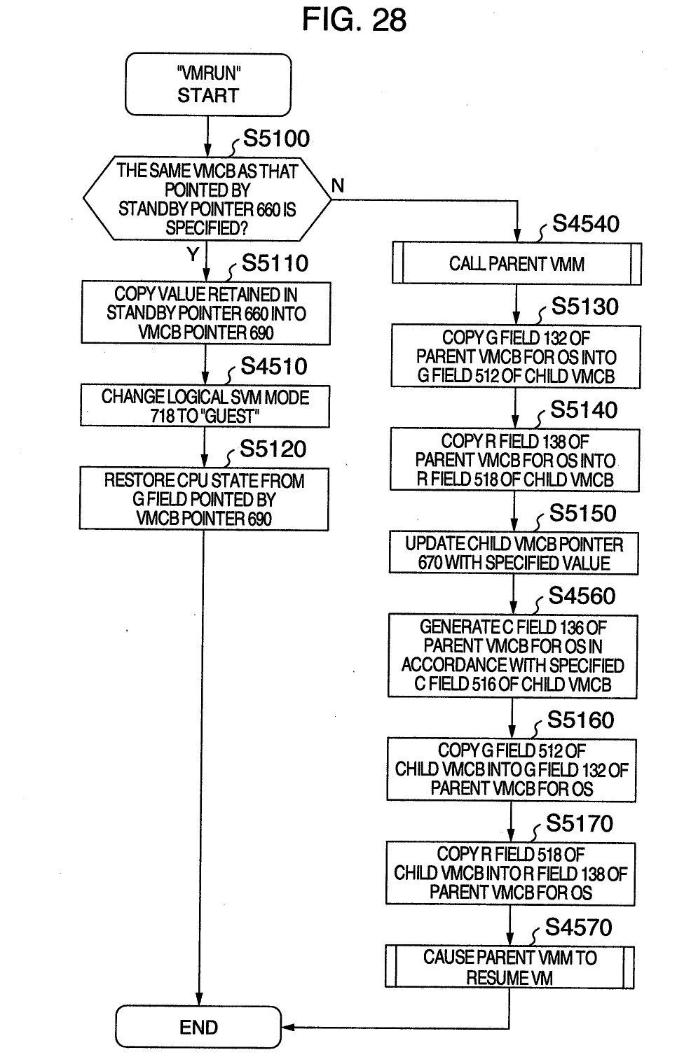

VMRUN processing conducted at S4440 shown in FIG. 23 will now be described with reference to FIG. 28.

In the present processing, changeover of a pointer for causing the OS/AP to operate is conducted. When changing over the child VMCB, the child VMCB before the changeover is updated to the latest state and the parent VMCB for OS corresponding to the child VMCB after the changeover is prepared prior to the pointer changeover.

At S5100, the CPU 70 compares the address of the child VMCB retained in the standby pointer 660 with an address of the child VMCB specified by the parameter of the VMRUN. If they coincide with each other, the processing proceeds to S5110. Otherwise, the processing proceeds to S4540.

At S5110, the CPU 70 reads out the value of the standby pointer 660, copies the value into the VMCB pointer 690, and prepares for resumption of the OS 50/AP 60.

At S4510, the CPU 70 changes the logical SVM mode 718 to “guest” and changes over the operation subject to the OS 50 or the AP 60 according to the CPL 719.

At S5120, the CPU 70 refers to the VMCB pointer 690, and restores the CPU state from the G field 132 (the third data structure which becomes the saving and restoration destination of the CPU state when interrupting and resuming the OS) of the parent VMCB for OS.

At S4540, the CPU 70 calls the parent VMM 20.

At S5130, the parent VMM 20 refers to the child VMCB pointer 670, and writes back a value retained in the G field 132 of the parent VMCB for OS, which is a temporary copy, into the G field 512 of the child VMCB.

At S5140, the parent VMM 20 refers to the child VMCB pointer 670, and writes back a value retained in the R field 138 of the parent VMCB for OS, which is a temporary copy, into the R field 518 of the child VMCB.

At S5150, the parent VMM 20 copies a parameter of the VMRUN instruction into the child VMCB pointer 670.

At S4560, the parent VMM 20 updates the C field 136 of the parent VMCB for OS so as to include all of events included in the C field 516 of the child VMCB specified by the parameter of the VMRUN instruction and events included in the C field 126 of the parent VMCB for child VMM.

At S5160, the parent VMM 20 refers to the child VMCB pointer 670, and copies the value retained in the G field 512 of the child VMCB into the G field 132 of the parent VMCB for OS, which is a temporary copy.

At S5170, the parent VMM 20 refers to the child VMCB pointer 670, and copies the value retained in the R field 518 of the child VMCB into the R field 138 of the parent VMCB for OS, which is a temporary copy.

At S4570, the parent VMM 20 releases the CPU 70 and causes the child VMM 40 to re-execute the VMRUN.

### <3.8. VMCB READ Processing>

The VMCB READ processing conducted at S4420 shown in FIG. 23 will now be described with reference to FIG. 17C.

At S3200, the field decision part 720 refers to the field partition table 400 by using an offset of the updated field, and finds the field partition 410 corresponding to a head offset 403 of an area including the offset and a size 406 of the area. If the field partition 410 indicates “to be processed by parent VMM,” calling of the parent VMM 20 is judged to be necessary and the processing proceeds to S3210. If the field partition 410 indicates “to be processed only by CPU,” calling of the parent VMM 20 is judged to be unnecessary and the processing proceeds to S3240.

At S3210, the CPU 70 calls the parent VMM 20.

At S5400, the parent VMM 20 refers to the child VMCB pointer 670, reads out the pertinent field of the active child VMCB 510, and updates the value in the memory or register in accordance with the parameter of memory READ.

At S3230, the parent VMM 20 releases the CPU 70 and causes the guest execution to be resumed.

At S3240, the CPU 70 refers to the standby pointer 660, reads out the pertinent field of the parent VMCB for OS 130, and updates the value in the memory or register in accordance with the parameter of memory READ.

### <3.9. VMCB WRITE Processing>

The VMCB WRITE processing conducted at S4430 shown in FIG. 23 will now be described with reference to FIG. 17D.

At S1120, the field decision part 720 refers to the field partition table 400 by using an offset of the updated field, and finds the field partition 410 corresponding to a head offset 403 of an area including the offset and a size 406 of the area. If the field partition 410 indicates “to be processed by parent VMM,” calling of the parent VMM 20 is judged to be necessary and the processing proceeds to S3300. If the field partition 410 indicates “to be processed only by CPU,” calling of the parent VMM 20 is judged to be unnecessary and the processing proceeds to S3350.

At S3300, the CPU 70 calls the parent VMM 20.

At S5510, the parent VMM 20 recognizes an update object by referring to the R field 128 of the parent VMCB for child VMM, and updates the pertinent field of the active child VMCB 510 by referring to the child VMCB pointer 670.

At S3320, the parent VMM 20 makes a decision whether the update object is the C field. If the update object is the C field, the processing proceeds to S3330. If the update object is the H field, the processing proceeds to S3340.

At S5530, the parent VMM 20 refers to the C field 516 of the child VMCB on the basis of a value retained in the child VMCB pointer 670, and updates the C field 136 of the parent VMCB for OS so as to include all events included in the C field 516 of the child VMCB.

At S3340, the parent VMM 20 releases the CPU 70 and causes the guest execution to be resumed.

At S3350, the CPU 70 refers to the standby pointer 660, and updates the pertinent field of the parent VMCB for OS 130.

### <4. Summary>

According to the embodiment described heretofore, update contents of the G field update of the child VMCB which is high in frequency are reflected directly to the parent VMCB for OS, and the pointer in the CPU is replaced for subsequent VMRUN. Since calling of the parent VMM which causes performance degradation can be avoided owing to the processing described heretofore, fast update and VMRUN can be implemented. On the other hand, if the C field is updated, then the parent VMM prepares the corresponding parent VMCB for OS instantly, and consequently the SVM function based on specifications can be given to the child VMM. Furthermore, since the function of the CPU is expanded only for the G field, the increase of the semiconductor quantity and power dissipation of the CPU can also be suppressed.

It should be further understood by those skilled in the art that although the foregoing description has been made on embodiments of the invention, the invention is not limited thereto and various changes and modifications may be made without departing from the spirit of the invention and the scope of the appended claims.

1. A control method in a virtual machine system which provides a plurality of virtual machines executed on a physical machine including a physical CPU and a storage part, wherein
the virtual machine system comprises:
a first virtual machine monitor which operates on the physical machine to provide the virtual machines; and
a second virtual machine monitor which operates on each of the virtual machines to execute a user program,
the second virtual machine monitor comprises:
a first data structure prescribing an event which becomes a condition of calling the second virtual machine monitor during operation of the user program; and
a third data structure which becomes a saving/restoration destination of a state of the physical CPU when interrupting/resuming the user program,
the first virtual machine monitor comprises:
a second data structure prescribing an event which becomes a condition of calling the first virtual machine monitor; and
a field partition table for managing the first data structure and the second data structure as data structures to be subject to update processing conducted by the first virtual machine monitor which is called by the physical CPU and managing the third data structure as a data structure to be subject to update processing conducted by the physical CPU, and
when the second virtual machine monitor updates the data structures:
if the first data structure is to be updated,
a physical CPU with the second virtual machine monitor designated as an operation subject thereof calls the first virtual machine monitor on the basis of the partition table, and
the called first virtual machine monitor updates the first data structure, and adds all of events prescribed in the updated first data structure to the second data structure; and
if the third data structure is to be updated,
the physical CPU with the second virtual machine monitor designated as the operation subject thereof updates the third data on the basis of the field partition table.

2. The control method in the virtual machine system according to claim 1, wherein
the field partition table retains an address of the first data structure in the storage part and an address of the third data structure in the storage part,
when the second virtual machine monitor updates the data structures,
the physical CPU with the second virtual machine monitor designated as the operation subject thereof refers to the field partition table and makes a decision whether an address of a data structure to be updated is an address of the data structure to be subject to update processing conducted by the first virtual machine monitor which is called by the physical CPU or an address of the data structure to be subject to update processing conducted by the physical CPU.

3. The control method in the virtual machine system according to claim 1, wherein
the first virtual machine monitor further comprises:
a fourth data structure prescribing an event which becomes a condition of calling the first virtual machine monitor during operation of the second virtual machine monitor; and
a fifth data structure which becomes a saving/restoration destination of the CPU state when interrupting/resuming the second virtual machine monitor,
the field partition table is a field partition table for managing the first data structure, the second data structure and the fourth data structure as data structures to be subject to update processing conducted by the first virtual machine monitor which is called by the physical CPU and managing the third data structure and the fifth data structure as data structures to be subject to update processing conducted by the physical CPU,
if the fourth data structure comprises OS resumption conducted by the second virtual machine monitor as an event,
then the physical CPU with the second virtual machine monitor designated as the operation subject thereof calls the first virtual machine monitor on the basis of the field partition table, and
the called first virtual machine monitor adds all of events prescribed in the first data structure and events prescribed in the fourth data structure to the second data structure,
if an event described in the second data structure has occurred during operation of the user program,
then the CPU state during operation of the user program is saved into the third data structure,
if an event described in the first data structure has occurred,
then the fourth data structure and the fifth data structure are activated and operation of the second virtual machine monitor is resumed,
if an event described in the fourth data structure has occurred during operation of the second virtual machine monitor,
then the CPU state during operation of the second virtual machine monitor is saved into the fifth data structure, and
when the second virtual machine monitor resumes operation of the user program,
the second data structure and the third data structure are activated and the operation of the user program is resumed.

4. The control method in the virtual machine system according to claim 3, comprising:
a procedure for adding an event of shifting control from the second virtual machine monitor to the user program, to the fourth data structure, when the first data structure has been updated; and
a procedure for updating the second data structure so as to cause the second data structure to include all events included in the first data structure, at time of shifting control from the second virtual machine monitor to the user program.

5. The control method in the virtual machine system according to claim 3, wherein
the CPU comprises:
first means for activating an address of a memory having a condition of calling the first virtual machine monitor stored therein; and
second means for activating a memory address of an area which becomes saving/restoration destination of the CPU state, when calling the first virtual machine monitor,
the second virtual machine monitor comprises the third data structure, and
the control method comprises:
a procedure for activating the second data structure by using the first means when starting the operation of the user program;
a procedure for activating the third data structure by using the second means when starting the operation of the user program;
a procedure for activating the fourth data structure by using the first means when starting operation of the second virtual machine monitor;
a procedure for activating the fifth data structure by using the second means when starting operation of the second virtual machine monitor; and
a procedure for causing the third data structure to be read/written when the second virtual monitor executes an instruction for reading/writing the third data structure.

6. The control method in the virtual machine system according to claim 3, wherein
the first virtual machine monitor comprises:
a first storage part area including the second data structure and the third data structure; and
a second storage part area including the fourth data structure and the fifth data structure,
the second virtual machine monitor comprises:
a sixth data structure which becomes saving/restoration destination of the CPU state when interrupting/resuming the user program; and
a third storage part area including the first data structure and the sixth data structure,
the CPU comprises:
first means for activating an address of a storage part area including an area storing a condition of calling the first virtual machine monitor and an area which becomes saving/restoration destination of the CPU state when calling the first virtual machine monitor; and
second means for activating an address of a data structure to be read/written by the second virtual machine monitor, and
the control method comprises:
a procedure for activating an address of the first storage part area by using the first means when starting the operation of the user program;
a procedure for activating an address of the second storage part area by using the first means when starting the operation of the second virtual machine monitor;
a procedure for activating an address of the first storage part area by using the second means when starting operation of the second virtual machine monitor; and
a procedure for causing the third data structure instead of the sixth data structure to be read/written when the second virtual machine monitor executes an instruction for reading/writing the sixth data structure.

7. A virtual machine system which provides a plurality of virtual machines executed on a physical machine including at least one physical CPU and storage part, wherein
the virtual machine system comprises:
a first virtual machine monitor which operates on the physical machine to provide the virtual machines; and
a second virtual machine monitor which operates on each of the virtual machines to execute at least one user program,
the second virtual machine monitor comprises:
a first data structure prescribing an event which becomes a condition of calling the second virtual machine monitor during operation of the user program; and
a third data structure which becomes a saving/restoration destination of a state of the physical CPU when interrupting/resuming the user program,
the first virtual machine monitor comprises:
a second data structure prescribing an event which becomes a condition of calling the first virtual machine monitor; and
a field partition table for managing the first data structure and the second data structure as data structures to be subject to update processing conducted by the first virtual machine monitor which is called by the physical CPU and managing the third data structure as a data structure to be subject to update processing conducted by the physical CPU, and
when the second virtual machine monitor updates the data structures:
if the first data structure is to be updated,
a physical CPU with the second virtual machine monitor designated as an operation subject thereof calls the first virtual machine monitor on the basis of the partition table, and
the called first virtual machine monitor updates the first data structure, and adds all of events prescribed in the updated first data structure to the second data structure; and
if the third data structure is to be updated,
the physical CPU with the second virtual machine monitor designated as the operation subject thereof updates the third data on the basis of the field partition table.

8. The virtual machine system according to claim 7, wherein
the field partition table retains an address of the first data structure in the storage part and an address of the third data structure in the storage part,
when the second virtual machine monitor updates the data structures,
the physical CPU with the second virtual machine monitor designated as the operation subject thereof refers to the field partition table and makes a decision whether an address of a data structure to be updated is an address of the data structure to be subject to update processing conducted by the first virtual machine monitor which is called by the physical CPU or an address of the data structure to be subject to update processing conducted by the physical CPU.

9. The virtual machine system according to claim 7, wherein
the first virtual machine monitor further comprises:
a fourth data structure prescribing an event which becomes a condition of calling the first virtual machine monitor during operation of the second virtual machine monitor; and
a fifth data structure which becomes a saving/restoration destination of the CPU state when interrupting/resuming the second virtual machine monitor,
the field partition table is a field partition table for managing the first data structure, the second data structure and the fourth data structure as data structures to be subject to update processing conducted by the first virtual machine monitor which is called by the physical CPU and managing the third data structure and the fifth data structure as data structures to be subject to update processing conducted by the physical CPU,
the storage part comprises an instruction for causing an event included in at least one of the first data structure and the fourth data structure to be described in the second data structure, an instruction for causing a decision whether an event described in the first data structure has occurred to be made, and an instruction for activating the fourth data structure and the fifth data structure and causing the operation of the second virtual machine monitor to be resumed if the event described in the first data structure has occurred,
if the fourth data structure comprises OS resumption conducted by the second virtual machine monitor as an event,
then the physical CPU with the second virtual machine monitor designated as the operation subject thereof calls the first virtual machine monitor on the basis of the field partition table, and
the called first virtual machine monitor adds all of events prescribed in the first data structure and events prescribed in the fourth data structure to the second data structure,
the physical CPU further makes a decision whether an event described in the second data structure has occurred during operation of the user program, and if an event described in the second data structure has occurred, the physical CPU saves a state of the user program into the third data structure,
the physical CPU further makes a decision whether an event described in the fourth data structure has occurred during operation of the second virtual machine monitor, and if an event described in the fourth data structure has occurred, the physical CPU saves a state of the second virtual machine monitor into the fifth data structure, and
when the second virtual machine monitor resumes operation of the user program, the second data structure and the third data structure are activated and the operation of the user program is resumed.

10. The virtual machine system according to claim 7, wherein
if the first data structure is updated, the physical CPU further adds an event of shifting control from the second virtual machine monitor to the user program, to the fourth data structure, and
the storage part further comprises an instruction for updating the second data structure so as to cause the second data structure to include all events included in the first data structure, at time of shifting control from the second virtual machine monitor to the user program.

11. The virtual machine system according to claim 7, wherein
the second virtual machine monitor comprises the third data structure,
the physical CPU further comprises:
first means for activating an address of a memory having a condition of calling the first virtual machine monitor stored therein; and
second means for activating a memory address of an area which becomes a saving/restoration destination of the CPU state, when calling the first virtual machine monitor,
the physical CPU further activates the second data structure by using the first means and activates the third data structure by using the second means, when starting the operation of the user program;
the physical CPU further causes the third data structure to be read/written when the second virtual monitor executes an instruction for reading/writing the third data structure, and
the storage part further comprises an instruction for activating the fourth data structure by using the first means and activating the fifth data structure by using the second means when starting operation of the second virtual machine monitor.

12. The virtual machine system according to claim 7, wherein
the second virtual machine monitor comprises:
a sixth data structure which becomes a saving/restoration destination of the CPU state when interrupting/resuming the user program; and
a third storage part area including the first data structure and the sixth data structure,
the CPU further comprises:
first means for activating an address of a storage part area including a condition of calling the first virtual machine monitor and an area which becomes a saving/restoration destination of the CPU state when calling the first virtual machine monitor; and
second means for activating an address of a data structure to be read/written by the second virtual machine monitor,
the storage part further comprises:
a first storage part area including the second data structure and the third data structure; and
a second storage part area including the fourth data structure and the fifth data structure,
the storage part further comprises an instruction for activating the second storage part area by using the first means when starting the operation of the second virtual machine monitor, and an instruction for activating the first storage part area by using the second means when starting operation of the second virtual machine monitor, and
the physical CPU further:
activates the first storage part area by using the first means when starting the operation of the user program;
and
causes the third data structure instead of the sixth data structure to be read/written when the second virtual machine monitor executes an instruction for reading/writing the sixth data structure.
